(19) United States
(12) Patent Application Publication
(10) Pub. No.: US 2007/0159532 A1
(43) Pub. Date: Jul. 12, 2007

(54) Image sensor test apparatus

(75) Inventor: Toshiyuki Kiyokawa, Tokyo (JP)

Correspondence Address: GREENBLUM & BERNSTEIN, P.L.C., 1950 ROLAND CLARKE PLACE, RESTON, VA, 20191, US

(73) Assignee: ADVANTEST CORPORATION, TOkyo (JP)

(21) Appl. No.: 10/599,374

(22) PCT Filed: Mar. 31, 2004
(86) PCT No.: PCT/JP04/04665

§ 371 Date: Sep. 27, 2006

(51) Int. Cl. H04N 17/00

(52) U.S. Cl. 348/187

(57) ABSTRACT

An image sensor test apparatus that emits light to a light receiving surface of an image sensor (DUT) and inputs and outputs electrical signals from a contact part to input and output terminals of the image sensor so as to test the image sensor (DUT) for optical characteristics, which captures an image of the image sensor (DUT) in the state held by a contact arm (315) by a first camera (326), recognizes a relative position of the image sensor (DUT) with respect to the contact part by image processing, adds a precalculated amount of deviation of an optical axis of the image sensor (DUT) with respect to an optical axis of a light source to that relative position to calculate an amount of alignment of the image sensor (DUT), drives a drive unit (322) based on this, and moves a holding side arm (317) abutting against a movable stage (321) with a lock-and L-free mechanism (318) in a free state.

### TECHNICAL FIELD

The present invention relates to an image sensor test apparatus bringing input and output terminals of a CCD, CMOS, or another image sensor into electrical contact wish a contact part of a test head, emitting light from a light source to the light receiving surface of the image sensor, and inputting and outputting electrical signals to and from the input and output terminals of the image sensor so as to test the optical characteristics of the image sensor.

### BACKGROUND ART

An electronic device test apparatus referred to as a “handler” places a large number of semiconductor integrated circuit chips or other electronic devices on a tray, conveys the tray to the inside of the handler, brings each electronic device under test into electrical contact with the test head, and tests it at the electronic device test apparatus body (hereinafter referred to as a “tester). Further, when finishing this test, it ejects each electronic device from the test head and reloads it on a tray in accordance with the test results so as to thereby classify it into a good device or defective device.

In tests of CCDs, CMOS's, and other image sensors among these electronic devices, in the same as the above, each image sensor is brought into electrical contact with the test head and classified in accordance with the test results. Further, in this test, the image sensor is brought into electrical contact with the test head and the light receiving surface of the image sensor is irradiated with light from a light source so as to conduct a pupil examination to examine whether the amount of received light of the image sensor is constant or not fixed or other test of the optical characteristics.

In this type of image sensor test, for example, when the lot of the image sensors under test is changed or the type of image sensors is otherwise changed, the relationship of the optical axis of each image sensor in the state positioned above the light source and the optical axis of the light source changes before and after the change of the type, so when running a test after the change of the type, the optical axis of the light source must be matched coaxially with the optical axis of the image sensor after the charge of the type in the state positioned above the light source by aligning the optical axis of the image sensor and the optical axis of the light source in advance.

To conduct this type of alignment, a conventional image sensor test apparatus is provided with a fine adjustment mechanism moving the light source itself to the XY-directions and positions the optical axis of the light source with respect to the optical axis or the image sensor by using this fine adjustment mechanism to move the light source itself.

Therefore, with this image sensor test apparatus, space allowing provision of this fine adjustment mechanism and movement of the light source was required around the light source, thus the image sensor type apparatus could not be sufficiently reduced in size.

### DISCLOSURE OF THE INVENTION

The present invention relates to an image sensor test apparatus testing the optical characteristics of a CCD, CMOS, or other image sensor and has as its object the provision of an image sensor test apparatus enabling reduction of the size of the hardware.

(1) To achieve the above object, according to a first aspect of the present invention, there is provided an image sensor test apparatus bringing input and output terminals of image sensors into contact with contact parts of a test head, emitting-light on light receiving surfaces of the image sensors, and inputting and outputting electrical signals with respect to input and output terminals of the image sensors from the test head so as to test at least one image sensor for optical characteristics, the image sensor test apparatus provided with at least a contact arm holding the image sensor and bringing the image sensor into contact with a contact part of the test head, a moving means provided at a base side and moving the contact arm, a light source emitting light to a light receiving surface of the image sensor, a calculating means for calculating a relative amount of deviation of an optical axis of the light receiving surface of the image sensor to an optical axis of the light source, and a correcting means for correcting the position of the contact arm in the state holding the image sensor based on the relative amount of deviation of the optical axis of the image sensor calculated by the calculating means (see claim 1).

According to the first aspect of the present invention, the calculating means calculate the relative amount of deviation of the optical axis of the image sensor with respect to the optical axis of the light source, and the correcting means corrects the position of the contact arm in the state holding the image sensor based on the relative amount of deviation of the optical axis of the image sensor.

When aligning the optical axis of the light source and the optical axis of the image sensor in this way, by correcting the position of the contact arm in the state holding the image sensor, a fine adjustment mechanism moving the light source itself in the XY directions becomes unnecessary at the light source side, so it is possible to reduce the size of the image sensor test apparatus and reduce the cost of the image sensor test apparatus.

In particular, in a test apparatus provided with a plurality of light source and able to test a plurality of image sensors, since fine adjustment mechanism for moving the light sources in the XY directions become unnecessary at the light source side, it is possible to easily narrow down the pitch between the plurality of light sources, possible to reduce the size of a test apparatus able to test a plurality of image sensors, and possible to reduce the cost of the test apparatus.

In the invention, while not particularly limited to this, preferably the apparatus is further provided with a first image capturing means for capturing an image of an image sensor in the state held at the contact arm from the light receiving surface side and an image processing means for recognizing the relative position of the image sensor in the state held at the contact arm with respect to the contact part based on image information captured by the first image capturing means, the correcting means provided at the base side and correcting the position of the contact arm in the state holding the image sensor based on the relative amount of deviation of the optical axis of the image sensor calculated by the calculating means and she relative position of the image sensor recognized by the image processing means (see claim 2).

In addition to the calculation of the amount of deviation using the calculating means, the first image capturing means captures an image of the image sensor held at the contact arm from the light receiving surface side, the image processing means recognizes the relative position of the image sensor in the state held by the contact arm with respect to the contact part based on the captured image information, and the correcting means corrects the position of the contact arm holding the image sensor based on the relative amount of deviation of the optical axis of the image sensor and the relative position of the image sensor with respect to the contact part.

When the correcting means provided at the base side corrects the position of the contact arm based on the relative position of the image sensor with respect to the contact part in this way, by considering the relative amount of deviation of the optical axis of the image sensor with respect to the optical axis of the light source for alignment of the position of each image sensor, it is possible to add the function of aligning the optical axis of the light source and the optical axis of the image sensor to the correcting means for aligning the position of the contact arm based on the relative position of the image sensor with respect to the contact part and there is no longer a need to provide a fine adjustment mechanism exclusively for the light source, so the image sensor test apparatus can be reduced in size and the image sensor test apparatus can be reduced in cost.

In particular, in a test apparatus provided with a plurality of light sources and able to test a plurality of image sensors, a fine adjustment mechanism moving each light source itself in the XY directions becomes unnecessary at the light source side, so it is possible to easily narrow down the pitch between the plurality of light sources, possible to reduce the size of a test apparatus able to test a plurality of image sensors, and possible to reduce the cost of the test apparatus.

Further, along with the narrowing of the pitch between the plurality of light sources, the pitch between the plurality of contact arms arranged with respect to them is also narrowed, so the weights of movable heads moved by the moving means are reduced, high speed movement of the moving means becomes possible, and poor contact of the contact parts and the input and output terminals of the image sensors can be prevented.

In the invention, while not particularly limited to this, preferably the calculating means calculates the relative amount of deviation of the optical axis of the image sensor with respect to the optical axis of the light source based on the electrical signals outputted from the input and output terminals of the image sensor with respect to the contact part of the test head while emitting light from said light source toward the light receiving surface of said image sensor in the state contacting said contact part (see claim 3).

By calculating the relative amount of deviation of the optical axis of an image sensor based on electrical signals actually outputted from the image sensor on which a light source emits light, it is possible to obtain an accurate grasp of the amount of deviation.

In the invention, while not particularly limited to this, preferably the image processing means recognize the relative position of the image sensor with respect to the contact part based on a chip of the image sensor in the image information captured by the first image capturing means (see claim 4) or preferably the image processing means recognizes the relative position of the image sensor with respect to the contact part based on input and output terminals of the image sensor in the image information captured by the first image capturing means (see claim 5).

By having the image processing means recognize the relative position of an image sensor with respect to the contact part based on the chip or the input and output terminals of the image sensor in the image information captured by the first image capturing means, it is possible to prevent poor contact even when a package is deviated from the chip itself or the input and output terminals in the image sensor.

In the invention, while not particularly limited to this, preferably the apparatus is further provided with a transparent carrying surface on which the image sensor is carried, the contact arm has an upper contact for electrically connecting the input and output terminals led out to the surface of the image sensor opposite to the light receiving surface to the contact part, and the carrying surface is movable to any position in an X-Y plane substantially parallel to the contact part (see claim 6).

By a contact arm having an upper contact, it is possible to also test a type of image sensor with input and output terminals led out to the surface opposite to the light receiving surface. Further, by placing an image sensor which had been held by a contact arm temporarily on a transparent carrying surface and making the input and output terminals of the image sensor match the upper contact of the contact arm by driving and positioning the carrying surface, it is possible to prevent poor contact.

In the invention, while not particularly limited to this, preferably the apparatus is further provided with a second image capturing means for capturing an image of the contact part, and the image processing means recognizes the relative position of the image sensor in the state held at the contact arm with respect to the contact part based on image information captured by the first image capturing means and the second image capturing means (see claim 7).

By having the second image capturing means capture an image of the contact part and recognizing and the relative position of the image sensor in the state held the contact arm with respect to the contact part based on this image information and image informant on captured by the first image capturing means, it is possible to obtain an accurate grasp of the relative position of the image sensor.

In the invention, while not particularly limited to this, preferably each contact arm is provided with a holding side arm holding the image sensor, a root side arm fixed to the moving means, and a lock-and-free means provided between the holding side and the root side arms and able to lock or free planar movement of the holding side arm with respect to the root side arm in an X-Y plane substantially parallel to the contact part (see claim 8).

When a contact arm is corrected by the correcting means, the lock-and-free means is set to free to enable the holding side arm to move relative to the root side arm, their, after the correction is finished, the lock-and-free means is set to lock to fix the holding side arm relative to the root side arm. Due to this, it is possible to provide the correcting means at not at each contact arm, but at the body side and the weight of each contact arm is reduced, so high speed movement of the moving means becomes possible and poor contact can be prevented.

In the invention, while not particularly limited to this, preferably each contact arm is further provided with a tilting means able to rotate the image sensor about any axis parallel to the X-Y plane (see claim 9).

When an image sensor contacts a contact part, even if the contact part is inclined, this tilting means car make the image sensor tilt to match the contact part, so it is possible to prevent poor contact.

In the invention, while not particularly limited to this, preferably the correcting means has drive units moving the holding side arm treed by the lock-and-free means to any position in the X-Y plane (see claim 10). Further, preferably the drive units include a first drive unit moving the holding side arm in the X-axial direction in the X-Y plane, a second drive unit moving the holding side arm in the Y-axial direction, and a third drive unit rotating the holding side arm about any point within the X-Y plane (see claim 11).

In the invention, while not particularly limited to this, preferably the carrying surface is moved in the X-Y plane by the drive units provided in the correcting means (see claim 12).

By driving the carrying surface by the drive units of the correcting means, it is no longer necessary to provide drive units for driving the carrying surface, so it is possible to reduce the size of the image sensor test apparatus and possible to reduce the cost of the image sensor test apparatus.

In the invention, while not particularly limited to this, preferably each holding side arm has one or more abutting members contacting the correcting means (see claim 13), and each abutting member is provided with either a projection or recess formed at a front end of the abutting member, and the correcting means is provided with the other of the projection or recess engageable with the above projection or recess (see claim 14).

By driving the correcting means in the state with the holding side arm of a contact arm and the correcting means engaged by an abutting member, hie contact arm car be made to accurately track the movement of the correcting means, so it is possible to accurate align of the position of the contact arm by the correcting means.

In the invention, while not particularly limited to this, preferably a reflecting means reflecting an image is provided on the optical axis of the first image capturing means (see claim 15).

By interposing the reflecting means on the optical axis of the first image capturing means, it becomes possible to place the first image capturing means on the base horizontally and it is possible to keep the height of the image sensor test apparatus low and reduce the size.

(2) To achieve the above object, according to a second aspect of the present invention, there is provided a method for testing an image sensor test method bringing input and output terminals of image sensors into contact with contact parts of a test head by contact arms, emitting light on light receiving surfaces of the image sensors from light sources, and inputting and outputting electrical signals with respect to input and output terminals of the image sensors from contact parts of the test head so as to test at least one image sensor for optical characteristics, the method for testing an image sensor provided with at least a calculating step of calculating a relative amount of deviation of an optical axis of the image sensor with respect to an optical axis of the light source and a first correcting step of correcting the position of the contact arm in the state holding the image sensor based on she relative amount of deviation of the optical axis of the image sensor calculated in the calculating step (see claim 16).

According to the second aspect of the present invention, in the calculating step the relative amount of deviation of the optical axis of the image sensor with respect to the optical axis of the light source is calculated and in she first correcting step the position of the contact arm in the state holding the image sensor based on the relative amount of deviation of the optical axis of the image sensor with respect to the optical axis of the light source is corrected.

When aligning the optical axis of a light source and the optical axis of an image sensor in this way, by correcting the position of a contact arm in the state holding the image sensor, a fine adjustment mechanism moving the light source itself in the XY directions becomes unnecessary at the light source side, thus it is possible to reduce the size of the image sensor test apparatus and reduce the cost of the image sensor test apparatus.

In particular, in a method of testing using a plurality of light sources to test a plurality of image sensors, since fine adjustment mechanisms for moving the light sources in the XY directions become unnecessary at the light source side, it is possible to easily narrow down the pitch between the plurality of light sources, possible to reduce the size of a test apparatus able to test a plurality of image sensors, and possible to reduce the cost of the test apparatus.

In the invention, while not particularly limited to this, preferably the apparatus is further provided with a first image capturing step of capturing an image of the image sensor in the state held at the contact arm from the light receiving surface side and a first recognizing step of recognizing the relative position of the image sensor in the state held at the contact arm with respect to the contact part based on image information captured in the first image capturing step, in the first correcting step the position of the contact arm in the state holding the image sensor is corrected based on the relative amount of deviation of the optical axis of the image sensor calculated in the calculating step and the relative position of the image sensor recognized in the first recognizing step (see claim 17).

In addition to the calculating step, in the first image capturing step an image of the image sensor held at the contact arm from the light receiving surface side is captured, in the first recognizing step the relative position of the image sensor in the state held by the contact arm with respect to the contact part is recognized based on the captured image information, and in the first correcting step the position of the contact arm in the state holding the image sensor is corrected based on the relative amount of deviation of the optical axis of the image sensor with respect to the optical axis of the light source and the relative position of the image sensor with respect to the contact part.

When correcting the position of the contact arm based on the relative position of the image sensor with respect to the contact part in this way, by considering the relative amount of deviation of the optical axis of the image sensor with respect to the optical axis of the light source for alignment of the position of each image sensor, it is possible to align the position of the contact arm based on the relative position of the image sensor with respect to the contact part and simultaneously align the optical axis of the light source and the image sensor, and there is no longer a need to provide a fine adjustment mechanism exclusively for the light source, so the image sensor test apparatus can be reduced in size and the image sensor test apparatus can be reduced in cost.

In the invention, while not particularly limited to this, preferably in the calculating step the relative amount of deviation of the optical axis of the image sensor with respect to the optical axis of the light source is calculated based on the electrical signals outputted from the input and output terminals of the image sensor with respect to the contact part of the test head (see claim 18).

By calculating the relative amount of deviation of the optical axis of the image sensor based on electrical signals actually outputted from the image sensor on which the light source emits light, it is possible to obtain an accurate grasp of the amount of deviation.

In the invention, while not particularly limited to this, preferably in the first recognizing step the a relative position of an image sensor with respect to a contact part is recognized based on a chip of the image sensor in the image information captured at the first image capturing step (see claim 19) or preferably in the first recognizing step the relative position of the image sensor with respect to the contact part is recognized based on input and output terminals of the image sensor in the image information captured in the first image capturing means (see claim 20).

By recognizing the relative position of the image sensor with respect to the contact part based on the chip or the input and output terminals of the image sensor in the image information captured in the first recognizing step, it is possible to prevent poor contact even when a package is deviated from the chip itself or the input and output terminals in the image sensor.

In the invention, while not particularly limited to this, preferably the method is further provided with a second imaging step of capturing an image of the contact arm in the state not holding the image sensor, a third image capturing step of capturing an image of the image sensor in a state not held by the contact arm from the light receiving surface side, a second recognizing step of recognizing a relative position of the image sensor with respect to the contact arm based on image information captured in the second imaging step and image information captured in the third imaging step, and a second correcting step of correcting the position of the image sensor in the state not held by the contact arm based or the relative position of the image sensor with respect to the contact arm recognized in the second recognizing step (see claim 21).

By recognizing the relative position of the image sensor with respect to the contact arm and correcting the position of the image sensor based on this, it is possible to prevent poor contact even when testing a type of image sensor with input and output terminals led out to the opposite side of the light receiving surface.

In the invention, while not particularly limited to this, preferably in the first recognizing step the relative position of the image sensor in the state held at the contact arm with respect to the contact part is recognized based on the image information capturing the contact part (see claim 22).

In this way, by recognizing the relative position of the image sensor in the state held by the contact arm with respect to the contact part based on the image information capturing the contact part in addition to the image information capturing the image sensor in the state held by the contact arm, the relative position of the image sensor with respect to the contact part can be accurately recognized.

In the invention, while not particularly limited to this, preferably the first correcting step includes a step of correcting a root side contact arm of the contact arm by making it move relative to a holding side contact arm of the contact arm in an X-Y plane substantially parallel to the contact part of the root side contact arm in the free state, then locking the root side contact arm with respect to the holding side contact arm (see claim 23).

By this, a correcting means for correcting the position of the contact arm in the state holding the image sensor is provided on the base side without being provided at each contact arm and the weight of the contact arms is reduced, so high speed movement of the moving means becomes possible and poor contact can be prevented.

### BRIEF DESCRIPTION OF THE DRAWINGS

Below, embodiments of the present invention will be explained with reference to the drawings.

FIG. 1A is a plan view shoving an image sensor under test of an image sensor test apparatus according to a first embodiment of the present invention.

FIG. 1B is a cross-sectional view of the image sensor along the I-I line of FIG. 1A.

FIG. 2 is a schematic plan view showing the image sensor test apparatus according to the first embodiment of the present invention.

FIG. 3 is a cross-sectional view of the image sensor test apparatus along the II-II line of FIG. 2.

FIG. 4 is a schematic cross-sectional view showing contact arms and test head of the image sensor test apparatus according to the first embodiment of the present invention.

FIG. 5 is a schematic cross-sectional view showing contact arms and alignment systems of the image sensor test apparatus according to the first embodiment of the present invention.

FIG. 6 is a schematic cross-sectional view showing the contact arms and alignment systems of the image sensor test apparatus in another example of the first embodiment of the present invention.

FIG. 7 is a top plan view showing a lock-and-free mechanism used for a contact arm in the first embodiment of the present invention.

FIG. 8 is a cross-sectional view of she lock-and-free mechanism along the III-III line of FIG. 7.

FIG. 9 is a cross-sectional view or the lock-and-free mechanism along the TV-TV line of FIG. 7.

FIG. 10 is a schematic side view showing the contact arms in still another example of the first embodiment of the present invention.

FIG. 11 is a view explaining an image sensor DUT profiling operation by the contact arm shown in FIG. 10.

FIG. 12 is an enlarged perspective view of a tilting function used in the contact arms shown in FIG. 10.

FIG. 13A and FIG. 13B are views explaining a profiling operation about the X-axis in a profiling operation of the contact arms shown in FIG. 10, where FIG. 13B is a view showing the state before the profiling operation, and FIG. 13B is a view showing the state after the profiling operation.

FIG. 14A and FIG. 14B are views explaining a profiling operation about the Y-axis in a profiling operation of the contact arms shown in FIG. 10, where FIG. 14A is a view showing the state before the profiling operation, and FIG. 14B is a view showing the state after the profiling operation.

FIG. 15 is a top plan view showing the drive unit of the alignment system of the first embodiment of the present invention.

FIG. 16 is a cross-sectional view of a drive unit along the V-V line of FIG. 15.

FIG. 17 is a cross-sectional view of the drive unit along the VI-VI line of FIG. 15.

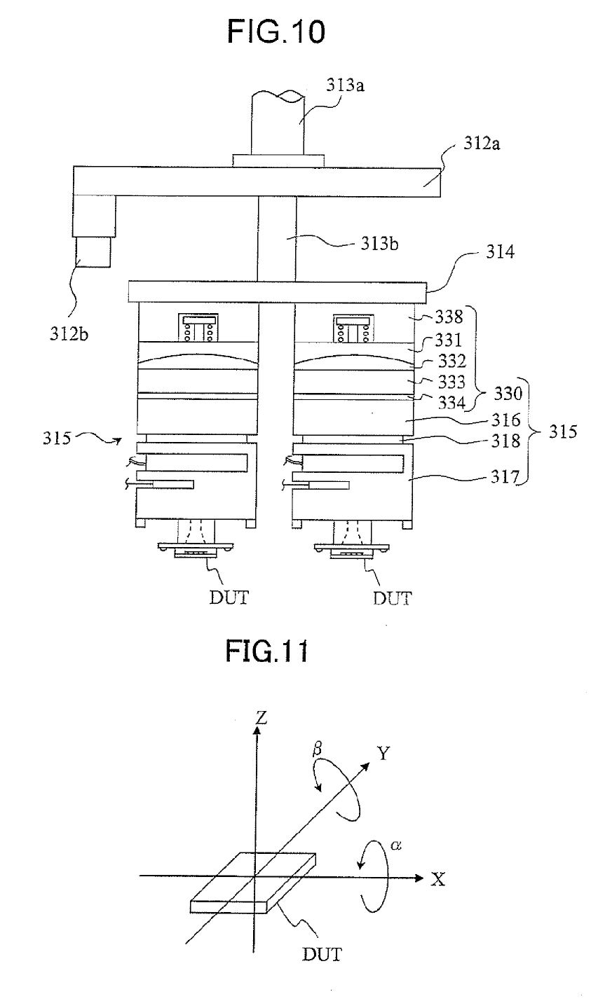

FIG. 10 is a block diagram showing the overall configuration of a control system of the image sensor test apparatus according to the first embodiment of the present invention.

FIG. 19 is a view showing the relationship of the optical axis of a light source and the optical axis of an image sensor in a pretest of the image sensor test apparatus according to the first embodiment of the present invention.

FIG. 20 is a view showing the relationship of the optical axis of a light source and the optical axis of an image sensor in a main test of the image sensor test apparatus according to the first embodiment of the present invention.

FIG. 21 is a view showing state of capturing an image of a contact part by a second camera when changing the type of device in the first embodiment of the present invention.

FIG. 22 is a view showing the state of positioning two image sensors of the second column and first row and the second column and second row above the alignment system during an alignment operation by the image sensor test apparatus according to the first embodiment of the present invention.

FIG. 23 is a view showing the state of insertion of an image sensor into the alignment system from the state of FIG. 22.

FIG. 24 is a flowchart slowing processing for alignment of the position of an image sensor in the first embodiment of the present invention.

FIG. 25A is a view showing an example of an image of the state before alignment in the first embodiment of the present invention, while FIG. 25B is a view showing an example of an image of the state after alignment of the first embodiment of the present invention.

FIG. 26 is a view showing the state of the completion of the alignment of two image sensors of the second column and first row and the second column and second row from the state of FIG. 23.

FIG. 27 is a view showing the state of four image sensors raised from the state of FIG. 26.

FIG. 28 is a view showing the state of positioning the two image sensors of the first column and first row and first column and second row above the alignment system from the state of FIG. 27.

FIG. 29 is a view showing the state of insertion of an image sensor in the alignment system from the state of FIG. 28.

FIG. 30 is a view showing the state of the completion of alignment of the two image sensors of the first column and first row and the first column and second row from the state of FIG. 29.

FIG. 31 is a view showing the state of four image sensors raised from the state of FIG. 30.

FIG. 32 is a view showing the state of running tests on four image sensors from the state of FIG. 31.

FIG. 33A and FIG. 33B are views showing a centering operation of the contact arm by the lock-and-free mechanism in the first embodiment of the present invention.

FIG. 34A is a top plan view showing an image sensor under test of an image sensor test apparatus according to a second embodiment of the present invention, FIG. 34B is a lower plan view of she image sensor shown in FIG. 34A, and FIG. 34C is a cross-sectional view of the image sensor along the VII-VII line of FIG. 34A.

FIG. 35 is a schematic cross-sectional view showing contact arms and a test head of the image sensor test apparatus according to the second embodiment of the present invention.

FIG. 36 is a schematic cross-sectional view showing the contact arms and alignment systems of the image sensor test apparatus according to the second embodiment of the present invention.

FIG. 37 is an enlarged schematic cross-sectional view of an upper contact of a contact arm shown in FIG. 35 and FIG. 36.

FIG. 38 is a plan view of the upper contact shown in FIG. 37.

FIG. 39 is a flowchart showing the processing for alignment of the position of an image sensor in the second embodiment of the present invention.

FIG. 40 is a view showing the state of a first camera capturing an image of an image sensor carried on a carrying surface of an alignment system in the second embodiment of the present invention.

FIG. 41 is a view showing the state of positioning of an image sensor at an upper contact from the state of FIG. 40.

FIG. 42 is a view showing a contact arm holding an image sensor positioned from the state of FIG. 41.

FIG. 43 is a detailed view showing the positional relationship of a contact arm, image sensor, and alignment system in the state of FIG. 42.

### BEST MODE FOR WORKING THE INVENTION

Below, embodiments of the present invention will be explained with reference to the drawings.

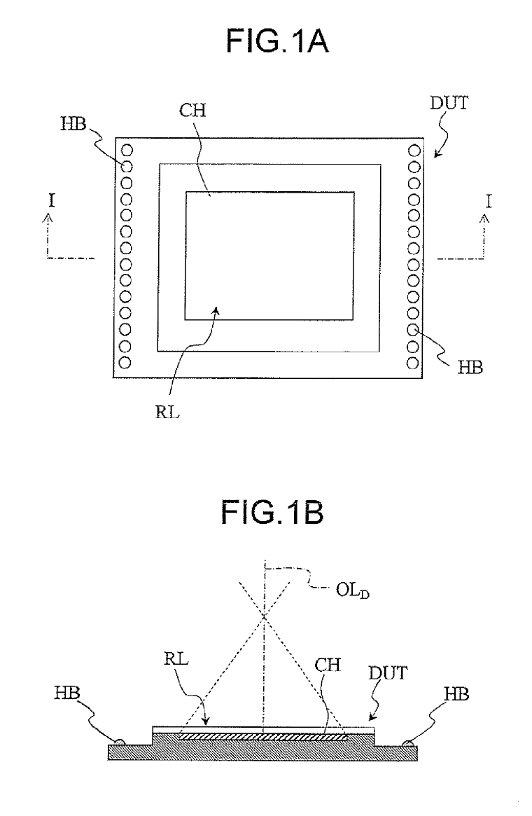

FIG. 1A is a plan view showing an image sensor under test of an image sensor test apparatus according to a first embodiment of the present invention, while FIG. 1B is a cross-sectional view of the image sensor along the I-I line of FIG. 1A.

First, explaining the image sensor under test in the first embodiment of the present invention, this image sensor DUT is a type of image sensor such as a CCD sensor, CMOS sensor, etc. having a chip CH having a microlens arranged at its approximate center part, having input and output terminals HB led out from its outer circumference, and having the chips CH and HB packaged as shown in FIG. 1A and having the input and output terminals HB led out to a plane the same as the light receiving surface RL where the microlens is formed in the chip CF as shown in FIG. 1B.

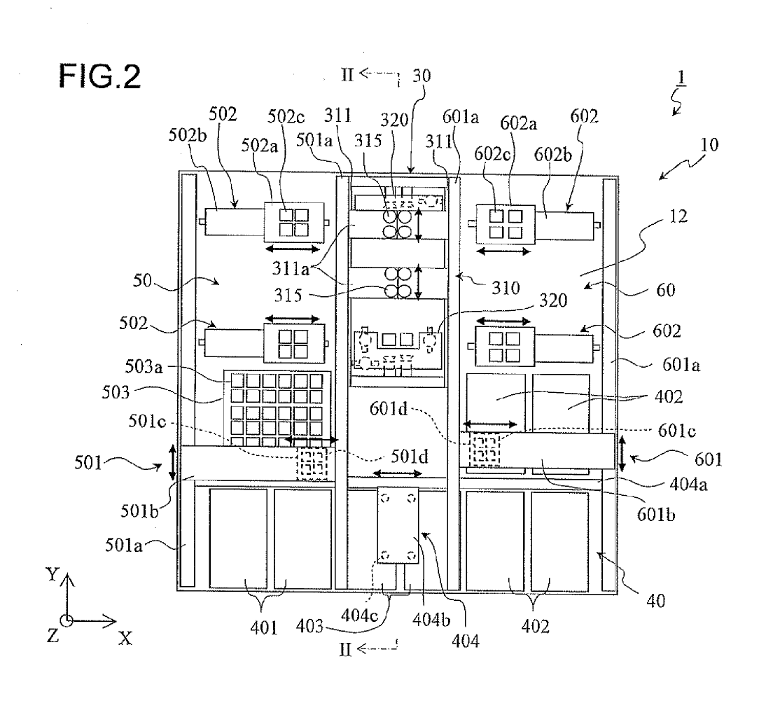

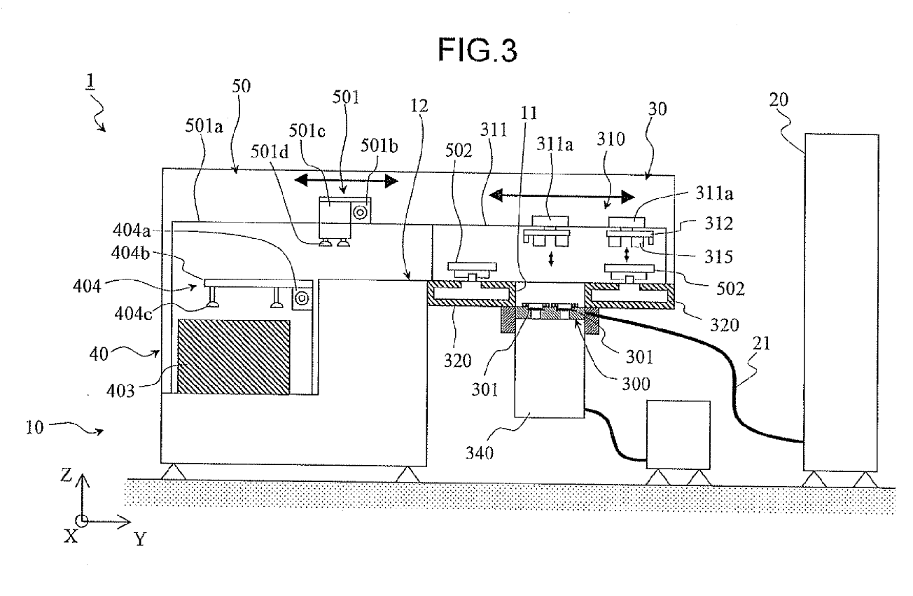

FIG. 2 is a schematic plan view showing the image sensor test apparatus according to the first embodiment of the present invention. FIG. 3 is a cross-sectional view of the image sensor test apparatus along the II-II line of FIG. 2.

The image sensor test apparatus 1 according to the first embodiment of the present invention is an apparatus for testing image sensors DUT of the type shown in the FIG. 1A and FIG. 1B. As shown in FIG. 2 and FIG. 3, it is provided with a handler 10 having a test unit 30, a sensor storage unit 40, a loader unit 50 and an unloader unit 60, a test head 300, and a tester 20 and simultaneously tests four image sensors DUT.

Further, this image sensor test apparatus 1 aligns pretest image sensors DUT, fed from the sensor storage unit 40 of the handler 10 through the loader unit 50 to the test unit 30, relative to the contact parts 301 of the test head 300 and axially aligns them with the light sources 340, then pushes them against the contact carts 301, emits light to the light receiving surfaces RL of the image sensors DUT from the light sources 340, inputs and outputs electrical signals to she image sensors BUT by the tester 20 to test them, then classifies and stores the image sensors DUT finished being tested in the sensor storage unit 40 through the unloader unit in accordance with the results of the tests.

Below, the units of this image sensor test apparatus 1 will be explained in detail.

Sensor Storage Unit 40

The sensor storage unit 40 is a means for storing the image sensors DUT before and after the tests and is configured by feed tray stockers 401, classification tray stockers 40, an empty tray stocker 403, and a tray conveyor system 404.

Each feed tray stocker 401 holds a plurality of stacked feed trays on which pluralities of pretest image sensors DUT are carried. In the present embodiment, as shown in FIG. 2, two feed tray stockers 401 are provided.

Each classification tray stocker 402 holds a plurality of stacked classification trays on which pluralities of tested image sensors DUT are carried. In the present embodiment, as shown in FIG. 2, four classification tray stockers 401 are provided.

By providing these four classification tray stockers 402, image sensors DUT can be classified and stored to a maximum of four classifications in accordance with the test results. That is, they may be classified into not only “good device” and “defective device” classifications, but also, among the “good devices”, devices with high operating speeds, medium operating speeds, and low operating speeds or, among “defective devices”, devices requiring retesting. Note that, for example, among the four classification tray stockers 402 of FIG. 2, the two classification tray stockers 402 close to the test unit 30 may store image sensors DUT having test results with relatively low frequencies of occurrence, while the two classification tray stockers 402 far from the test head 300 may store image sensors DUT having test results with relatively high frequencies of occurrence.

The empty tray stocker 403 stores the empty trays after all of the pretest image sensors carried in the feed tray stockers 401 are fed to the test unit 30.

The tray conveyor system 404 is a conveying means movable in the N-axial and Z-axial directions in FIG. 2 and is configured by an X-axial rail 404a, a movable head 404b, and four suction cads 404c and has a range including the feed tray stockers 401, part of the classification tray stockers 402, and the empty tray stocker 403 as its range of operation.

Further, in this tray conveyor system 404, the N-axial rail 404a fixed on the base of the handler 10 supports the movable head 404b to be movable in the X-axial direction in a cantilever fashion. This movable head 404b is provided with a not particularly shown Z-axial actuator and four suction pads 404c at its front end.

The tray conveyor system 404 picks up and holds an empty tray emptied in a feed tray stocker 401 by the suction pads 404c, raises it by the Z-axial actuator, and slides the movable head 404b on the X-axial rail 404a to transport the tray to the empty tray stocker 403.

Similarly, when the post-test image sensors DUT are fully loaded on a classification tray, the classification tray stocker 402 picks up and holds an empty tray from the empty tray stocker 403, raises it by the Z-axial cactuator, and slides the movable head 404b on the X-axial rail 404a to transport it to the classification tray stocker 402.

Note that while the drawing is omitted, each of the stockers 401 to 403 is provided with an elevator capable of raising a tray in the 2-axial direction. The tray conveyor system 404, as shown in FIG. 3, is provided so that its range of operation does not overlap the ranges of operation of the later-mentioned first and second conveyor systems 501 and 601 in the Z-axial direction, so the operation of the tray conveyor system 404 and the operation of the first and second XYZ conveyor systems 506 and 601 do not interfere with each other.

Note that the number of stockers in the present invention is not particularly limited to the number explained above and can be suitably set according to need.

Loader Unit 50

The loader unit 50 is a means for feeding image sensors DUT from a feed tray stocker 401 of the sensor storage unit 40 to the test unit 30 and is comprised of the first XYZ conveyor system 501, two loader buffers 502, and a heat plate 503.

The first XYZ conveyor system 501 is a means for moving the image sensors DUT carried on a feed tray of a feed tray stocker 401 of the sensor storage unit 40 to the heat plate 503 and moving image sensors DUT given predetermined thermal stress on this heat plate 503 to a loader buffer 502. It is comprised of Y-axial rails 501a an X-axial rail 501b, a movable head 501c, and suction pads 501d and has a range including the feed tray stockers 401, the heat plate 503, and two loader buffers 502 as a range of operation.

As shown in FIG. 2, the two Y-axial rails 501a of this first XYZ conveyor system 501 are fixed on the base 12 of the handler 10. Between these, the X-axial rail 501b is supported slidably in the Y-axial direction. Further, this X-axial rail 501b supports a movable head 501c having a (not shown) Z-axial actuator slidably in the X-axial direction. Further, this movable head 501c has four suction pads sold at its bottom end and drives the 2-axial actuator to enable the four suction pads 501d to be raised in the Z-axial direction.

The first XYZ conveyor system 501 positions the four suction pads 501d over four image sensors GUTS carried on a feed tray, picks up the four image sensors DUT all at once, moves them to the heat plate 503, positions them at wells 503a formed in the surface, then releases the DUTs.

The heat plate 503 is a heating means for applying predetermined thermal stress to the image sensors DOT and is, for example, a metal plate provided with a heat source (not shown) at its bottom. The upper surface of this heat plate 503 is formed with a plurality of wells 503a into which the image sensors DUT can be dropped. The pretest image sensors DUT are moved by the first XYZ conveyor system 501 from the feed tray stocker 401 to the wells 503a. Further, after the image sensors DUT are heated to a predetermined temperature by the heat plate 503, the image sensors DUT are moved by the first XYZ conveyor system 501 to a loader buffer 502.

Note that, as later explained, before the test, alignment systems 320 align the positions of the image sensors DUT, so it is also possible not to provide the heat plate 503 with the wells 503a, but to take the surface of the heat place 503 a simple flat surface and make the first XYZ conveyor system 501 place the image sensors DUT on this flat surface. Further, it is also possible to make the surface of the heat plate 503 a flat surface provided with suction pads with suction surfaces facing vertically upward, have one XYZ conveyor system 501 place the image sensors CUT on the suction pads, and have the image sensors DUT picked up by the suction pads provided on the heat plate 503.

Each loader buffer 502 is a means for moving backwards and forwards the image sensors DUT between the range of operation of the first XYZ conveyor system 501 and the range of operation of the YZ conveyor system 310 (later explained) of the test unit 30 and is comprised of a movable part 502a and an X-axial actuator 502b.

The movable part 502a is supported at one end of the X-axial actuator 502b fixed on the base 12 of the handler 10. The top surface of this movable part 502a is formed with four wells 502c in which the image sensors BUT can be dropped. The first XYZ conveyor system 501 picks up, holds, and moves four pretest image sensors DUT heated to a predetermined temperature on the heat plate 503 all at once and releases the image sensors DUT in the wells 502c of a loader butter 502. The loader buffer 502 holding the four image sensors DUT extends its X-axial actuator 502b to move the image sensors DUT from the range of operation of the first XYZ conveyor system 501 to the ins de of the range of operation of the YZ conveyor system 310.

Note that it is also possible not to provide the wells 502c on the movable part 502a, but, for example, make the surface of the movable part 502a a flat surface provided with suction pads with suction surfaces facing vertically upwards. In this case, the first XYZ conveyor system 501 places the image sensors DUT or the suction pads, has the suction pads pick up the image sensors DUT, then extends the X-axial actuator 502b. When the movement within the range of operation of the YZ conveyor system 310 is finished, it releases the suction of the suction pads and the YZ conveyor system 310 holds the image sensors DUT.

By providing the loader buffers 502, it is possible for the first XYZ conveyor system 501 and the YZ conveyor system 310 to be operated without interfering with each other.

Further, by providing two loader buffers 502 as in the present embodiment, it is possible to feed the image sensors DUT to the test head 300 efficiently and improve the operation rate of the image sensor test apparatus 1.

Note that, in the present invention, the number of loader buffers 502 is not particularly limited to two and can be appropriately set from the time required for alignment of the positions of the later explained image sensors DUT and the time required for testing of the image sensors DUT.

Test Unit 30

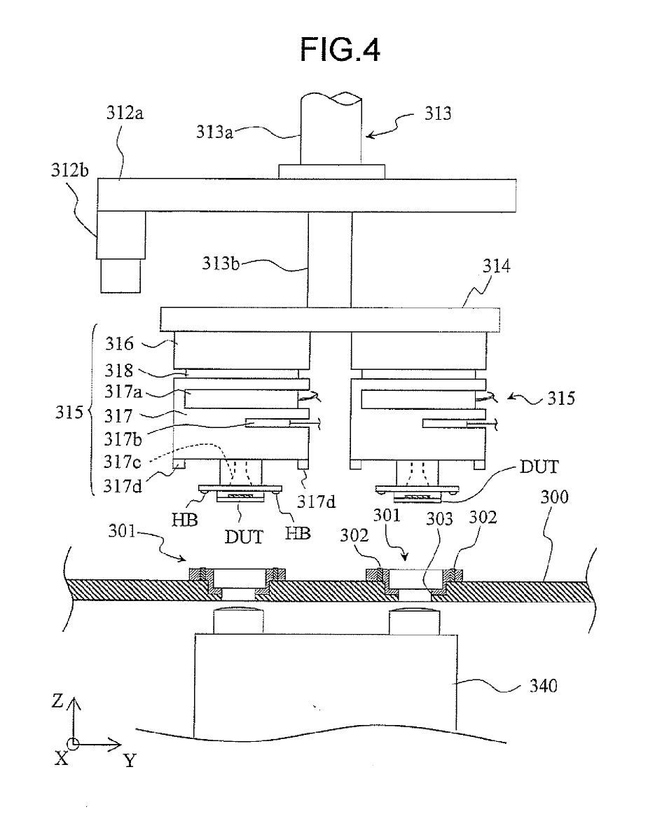

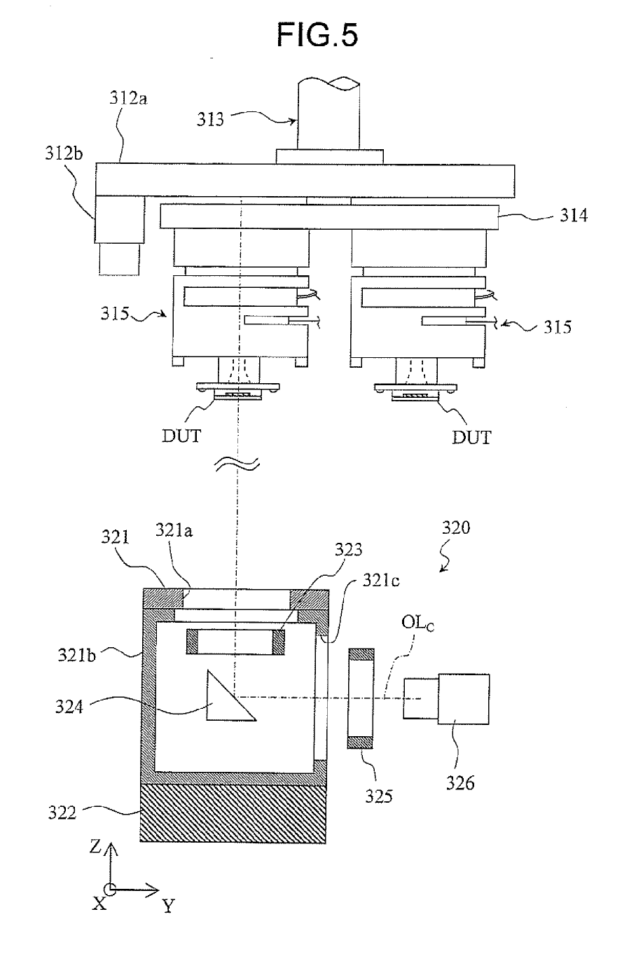

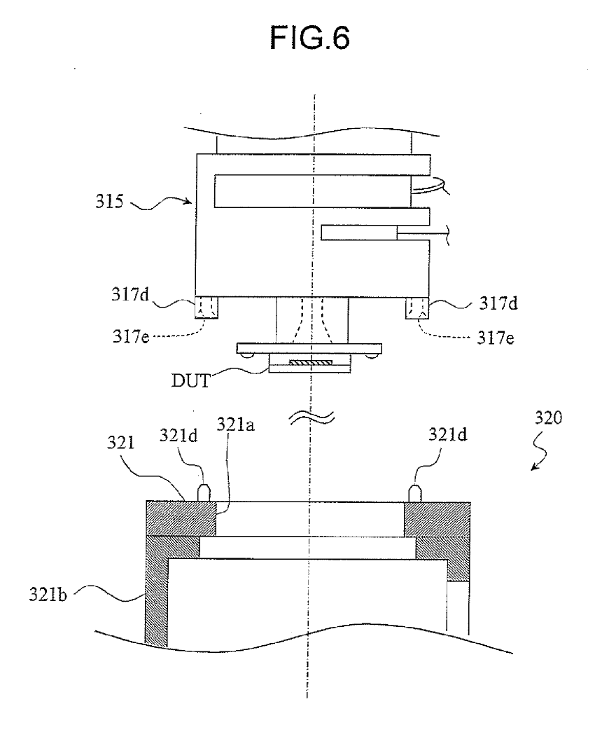

FIG. 4 is a schematic cross-sectional view showing contact arms and test head of the image sensor test apparatus according to the first embodiment of the present invention, FIG. 5 is a schematic cross-sectional view showing contact arms and alignment systems of the image sensor test apparatus according to the first embodiment of the present invention, and FIG. 6 is a schematic cross-sectional view showing the contact arms and alignment systems of the image sensor test apparatus in another example of the first embodiment of the present invention.

The test unit 30 is a means for aligning the positions of the image sensors DUT, then bringing the input and output terminals HB of the image sensors DUT into electrical contact with the contact pins 302 of the contact parts 301, emitting light to the light receiving surfaces RL of the image sensors PUT, and inputting electrical signals to the image sensors DUT from the tester 20 through the contact parts 301 of the test head 300 so as to test the image sensors DUT for optical characteristics to determine whether the amounts of light received by the image sensors DUT are constant and is comprised of the YZ conveyor system 310, four alignment systems 320 (correcting means), and four light sources 340.

First, the test head 30 used in this test unit 30 will be explained. As shown in FIG. 4, this test head 300 is comprised of four contact parts 301 arrayed on a board in two columns and two rows. These are arranged in an array that substantially matches the array of the four contact arms 315 of the movable head 312 of the later explained YZ conveyor system 310.

Each contact part 301 is provided with a plurality of contact pins 302. These contact pins 302 are arranged so as to substantially match the array of the input and output terminals HB of the image sensor DUT under test.

This test head 300, as shown in FIG. 3, is detachably attached to the handler 10 as to shut the opening 11 formed in the base 12 of the handler 10. Each contact part 301, as shown in the same figure, is electrically connected to the tester 20 through a cable 21.

Further, in the image sensor test apparatus 1 according to the present embodiment, as shown in FIG. 4, openings 303 are formed in the approximate centers of the contact parts 301 of the test head 303 so that it is possible to emit light toward she light receiving surfaces RL of the image sensors DUT from the bottom. Each opening 303 has a size of an extent enabling visual confirmation of the light receiving surface from the bottom.

When the shapes of the image sensors DUT or the array of the input and output terminals HB are charged due to a change of the type of the image sensors DUT, it is possible to change to another test head 300 matching with the image sensors DUT after the change to enable one image sensor test apparatus to test various types of image sensors DUTs.

The test unit 30 of the image sensor test apparatus 1 according to the present embodiment, as shown in FIG. 3 and FIG. 4A, is provided with light sources 340 able to emit light vertically upward fixed relative to the base 12 of the handler 10 below the openings 303 formed at the contact parts 301. Further, the light sources 340 can simultaneously emit light through the openings 303 formed in the four contact parts 301 to the light receiving surfaces RL of the four simultaneously tested image sensors DUT.

The YZ conveyor system 310 of the test unit 30 is a means for moving the image sensors DUT between the alignment systems 320 and the test head 300 and supports the alignment of the positions of the image sensors DUT by the alignment systems 320 and supports the testing of the image sensors DUT by the test head 300.

This YZ conveyor system 310, as shown in FIG. 2 and FIG. 3, supports two X-axial direction support members 311a at a pair of Y-axial rails 311 fixed on the base 12 of the handler 10 slidably in the Y-axial direction. Further, each X-axial direction support member 311a supports a movable head 312 at its approximate center and has a range including the alignment systems 320 and the contact parts 301 of the test head 300 as a range of operation.

This YZ conveyor system 310 is provided with two movable heads 312, so by having one movable head 312 running a test and, during this, having the other movable head 312 aligns the positions of the image sensors DUT, it becomes possible to raise the operating rate of the test head 300. Note that, during this, the movable heads 312 simultaneously operating on the pair of Y-axial rails 311 and supported on the two X-axial direction support members 311 are controlled so that they do not interfere with each other's operations.

Each movable head 312, as shown in FIG. 4 and FIG. 5, is provided with a camera support member 312a, a second camera 312h (second image capturing means), one Z-axial actuator 313, one root part 314, and four contact arms 315 corresponding to the array of the contact parts 301. The four image sensors DUT supported en the contact arms 315 can be moved in the Y-axial direction and the Z-axial direction. Further, each contact arm 315 is provided with a holding side arm 317, a lock-and-free mechanism 310, and a root side arm 316. Note that, the four image sensors DUT of the present embodiment will the explained according to the following arrangement with, in FIG. 2, the two contact arms 315 positioned in the Y-axial positive direction as the first row, the two contact arms 315 positioned in the Y-axial negative direction as the second row, the two contact arms 315 positioned in the X-axial negative direction as the first column, and the two contact arms 315 positioned in the X-axial positive direction as the second column.

One end of the body 313a of the Z-axial actuator 313 of each movable head 312 is fixed to an X-axial direction support member 311a, while the other end supports the camera support member 312a. Further, at an end of this camera support member 312a at the test head 330 side, the second camera 312b for capturing an image of the contact parts 301 of the test head 300 is provided so that its optical axis becomes the Z-axial negative direction.

Note that, the position of provision of the second camera in the present invention is not particularly limited to the above position of provision. For example, it is also possible to provide the second camera 312b at the end of the root part 314 at the test head 300 side. Due to this, the second camera 312b can be moved by the Z-axial actuator 313 in the Z-axial direction, so it is possible to change the focus of the second camera 312b along with the drive operation of the Z-axial actuator 313 or adjust the luminance when the second camera 312b has a lighting function.

The front end of a movable rod part 313h of the Z-axial actuator 313 of the movable head 312 has the root part 314 fixed to it. In accordance with the drive operation of this Z-axial actuator 313, the root part 314 is raised or lowered in the Z-axial direction. Further, four root side arms 316 are fixed at the root part 314 by pitches corresponding to the four contact parts 301 of the test head 300. Each root side arm 316 is provided at its bottom end face with a holding side arm 317 through a lock-and-free mechanism 318.

Each holding side arm 317 has a suction pad 317c for picking up an image sensor DUT at the center of its bottom. Further, this holding side arm 317 has a heater 317a and a temperature sensor 317b embedded in it. By maintaining the high temperature thermal stress applied at the heat plate 503 by the heater 317a and having the temperature sensor 317b detect the temperature of the holding side arm 317, the temperature of the image sensor DUT is indirectly detected and used for ON/OFF control of the heater 317a.

Further, each holding side arm 317 is provided at its bottom end with an abutting member 317d projecting nut in the Z-axial negative direction. By the holding side arm 317 having an abutting member 317d in this way, when the movable head 312 applies predetermined pressure to the alignment movable stage 321, the holding side arm 317 is supported at the alignment system 320 by this abutting member 317d. When the lock-and-free mechanism 318 is in the free state, the holding side arm 317 can track the motion of the movable stage 321 (explained later) of the alignment system 320 (for example, see FIG. 26).

Note that, as shown in FIG. 6, by forming a recess 317e at the from end of the abutting member 317d and providing a projection 321d corresponding to this recess 317e around the first opening 321a of the movable stage 321 of the alignment system 320 and engaging the recess 317e and projection 321d, the trackability in alignment of the position of the image sensor DUT can be improved. Further, the edge of the opening of the recess 317d or the outer circumference of the front end of the projection 321d may be tapered to facilitate positioning of the holding side arm 317 with respect to the movable stage 321. Further, for example, it is possible to provide a suction pad, magnet, etc. at the front end of the abutting member 317d and edge of the first opening 321a of the movable stage 321 to further improve the trackability of the position of ad image sensor DUT.

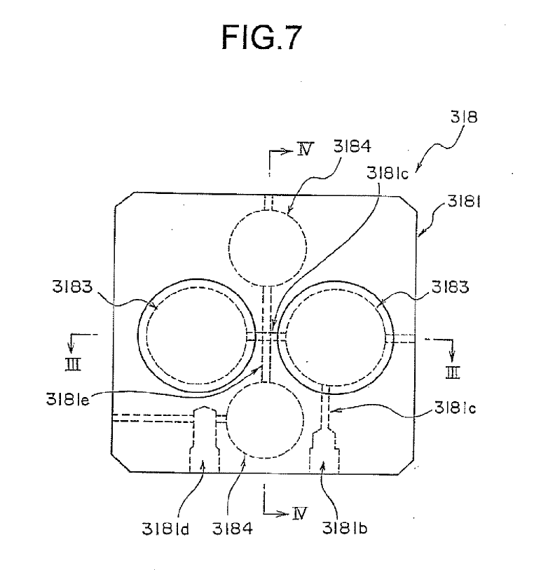

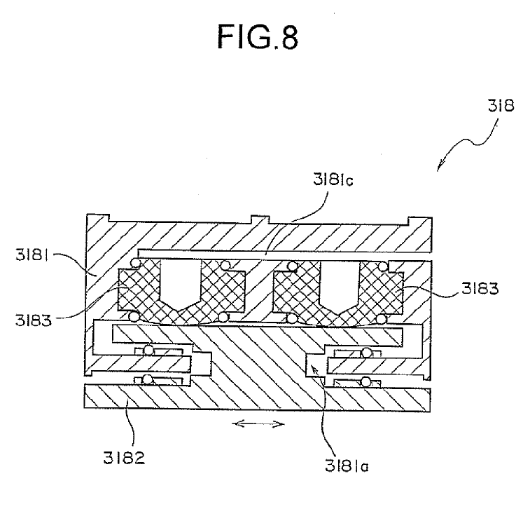

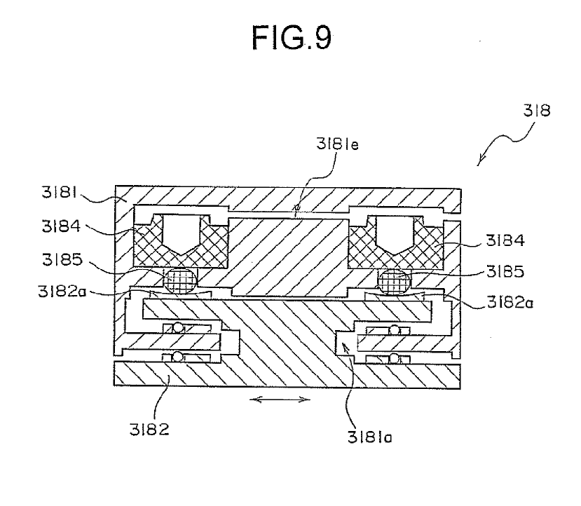

FIG. 7 is a too plan view showing a lock-and-free mechanism used for a contact arm in the first embodiment of the present invention, FIG. 8 is a cross-sectional view of the lock-and-free mechanism along the III-III line of FIG. 7, and FIG. 9 is a cross-sectional view of the lock-and-free mechanism along the IV-IV line of FIG. 7.

The lock-and-free mechanism 318 used for each contact arm 315 in the present embodiment is a means for freeing or locking planar motion of the holding side aim 317 in the state picking us and holding an image sensor DUT with respect to the root side arm 316 in a plane substantially parallel to the contact part 301, that is, movement in the X-axial and Y-axial directions and θ-rotation about the Z-axis. Further, as shown in FIG. 33A and FIG. 33B, it has a centering function of releasing the image sensor DUT, then making the centerline CL_{H} of the holding side arm 31.7 substantially match with the centerline CL_{R} of the root side arm 316 by returning the holding side arm 317 to the origin.

As shown in FIG. 7 to FIG. 9, this lock-and-free mechanism 318 is comprised of a fixed part 3181, a movable part 3182, locking pistons 3183, centering pistons 3184, and centering balls 3185.

The fixed part 3181 of the lock-and-free mechanism 318 has a substantially rectangular columnar outer shape and receives part of the movable part 3192 by being formed with a hollow part at the inside of its bottom side. A circular opening 3181a is provided at the center of the bottom surface of the fixed part 3181 so as to hold the movable part 3182 received in that hollow part in a manner enabling planar motion.

Further, this fixed part 3181 is formed inside it with holding parts for holding two locking pistons 3183, two centering pistons 3184, and two centering balls 3185. Further, this fixed part 3181 is formed at one side surface with a locking use air feed port 3181b for supplying air to the locking pistons 3183 and is formed with a locking use air passage 3181c from the locking use air feed port 3181b to the two locking pistons 3183.

Further, this fixed part 3181 is formed at one side surface with a centering use air feed port 3181d for feeding air to the centering pistons 3184 and is formed with a centering air passage 3181e from the centering use air feed port 3181d to the two centering pistons 3184. Note that the locking use air passage 3181c and the centering use air passage 3181e do not intersect.

The movable part 3182 of the lock-and-free mechanism 318 has a substantially cylindrical shape constricted at its middle. The part above this constricted part is received in the hollow part inside the bottom of the fixed part 3181, while the constricted part is positioned at the opening 3181a, whereby this movable part 3182 is held by the fixed part 3181, suppressed in motion in the Z-axial direction, and allowed movement in the X-axial and Y-axial directions and θ rotation about the Z-axis.

Further, this movable part 3182 has two bearing parts 3182a with top surfaces with concave arcuate shapes for supporting the centering balls 3185. These bearing parts 3182a can support the centering balls 3185. These bearing parts 3182a are provided at the top surface of the movable part 3182 so that the centers of the concave arcuate shapes match with the centerlines of the centering pistons 3184 at the time of centering.

The locking pistons 3183 of the lock-and-free mechanism 318 are held in holding parts formed in the fixed part 3181. The bottom end faces of the locking pistons 3183 contact the top surface of the movable part 3182.

Further, the centering pistons 3184 are held in holding parts formed in the fixed part 3181 and abut against the centering balls 3185 at their bottoms.

The centering balls 3185 of the lock-and-free mechanism 318 have substantially spherical shapes. Movement in the X-axial and Y-axial directions is constrained by the inside walls of the holding parts formed in the fixed part 3181. Further, the centering balls 3185 abut against the centering pistons 3184 at their toss and abut against the bearing parts 3102a provided at the top surface of the lock-and-free movable part 3182 at their bottoms.

When setting the lock-and-free mechanism 318 in the free state, none of the pistons, that is, the two locking pistons 3183 and the two centering pistons 3184, are supplied with air and the movable part 3182 is set to enable planar movement with respect to the fixed part 3181.

When setting the lock-and-free mechanism 318 in the lock state, the two locking pistons 3183 are supplied with air and the movable part 3182 is fixed to the fixed part 3181. Note that the two centering pistons 3184 are not supplied with air.

When centering the lock-and-free mechanism 318, the supply of air to the two locking pistons 3183 is stopped and the movable part 3182 is set once to the free state, then the two centering pistons 3184 are supplied with air to push against the centering balls 3185 and match with the concave arcuate shapes formed at the top surfaces of the bearing parts 3182a to be positioned at the centers of the concave arcuate shapes. By the operation of these two centering balls 3185, the movable part 3182 is centered with match with the fixed part 3181.

This lock-and-free mechanism 318 is attached to the bottom end face of the root side am 316 by the top end face of the fixed part 3181 and is attached to the top end face of the holding side arm 317 by the bottom end face of the movable part 3182. The lock-and-free mechanism 318 is provided between the root side arm 316 and holding side arm 317 to thereby configure a contact arm 315.

By providing such a lock-and-free mechanism 318 between the root side arm 316 and the holding side arm 317, a drive means for the alignment of the position of an image sensor DUT does not have to be provided at each holding side arm 317, the weight of each movable heads 312 of the YZ conveyor system 310 can be lightened, high speed movement of the movable head 312 is made possible, and the frequency of occurrence of poor contact between image sensors DUT and contact parts 301 can be reduced.

Further, as shown in FIG. 10, each contact arm 315 may be provided with a tilting mechanism 330 between the root part 324 and the root side arm 316. Due to this, even if the contact part 301 is somewhat inclined, the contact arm 315 can be tilted to match with the contact part 301 and thereby enable an image sensor DUT to be effortlessly brought into contact with the contact part 301.

This tilting mechanism 330 is a suspended type tilting means for tilting an image sensor DUT held at the suction pad 317c of the holding side arm 317 with respect to an X-Y plane parallel to the contact part 301. As shown in FIG. 11, this enables α rotation about an X-axis substantially parallel to the X-Y plane parallel to the contact part 301 in the image sensor BUT and β rotation about a Y-axis substantially parallel to the plane.

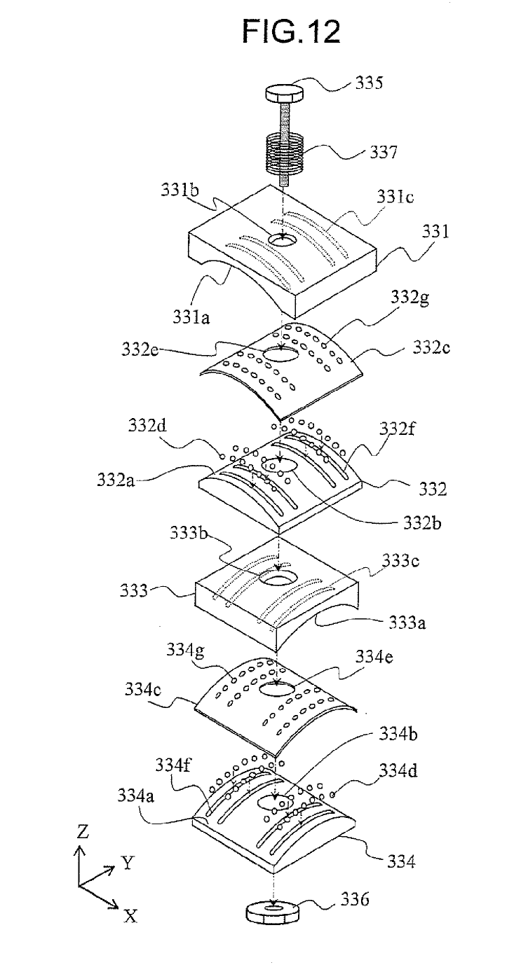

This tilting mechanism 330, as shown in FIG. 12, is comprised of a Y-axial rotation receiving member 331 and Y-axial rotating member 33a for rotating about the Y-axis, an X-axial rotation receiving member 333 and X-axial rotating member 334 for rotating about the X-axis, a bolt 335 and nut 336 for fastening these together in a slidable manner, a spring 337 for giving suitable elastic force for centering, and a linking member 338 for linking the base member 340 and the tilting mechanism 330.

As shown in FIG. 12, the Y-axial rotation receiving member 331 is formed at its bottom surface with a first concave arcuate shape 331a along the peripheral direction about the Y-axis and is formed at its approximate center with a first through hole 335b through which a bolt 335 is passed. As opposed to this, the Y-axial rotating member 332 is formed at its top surface with a first convex arcuate shape 332a with a shape corresponding to the first concave arcuate shape 331a of the Y-axial rotation receiving member 331 and is formed at its approximate center part with a second through hole 332b through which a bolt 335 is passed.

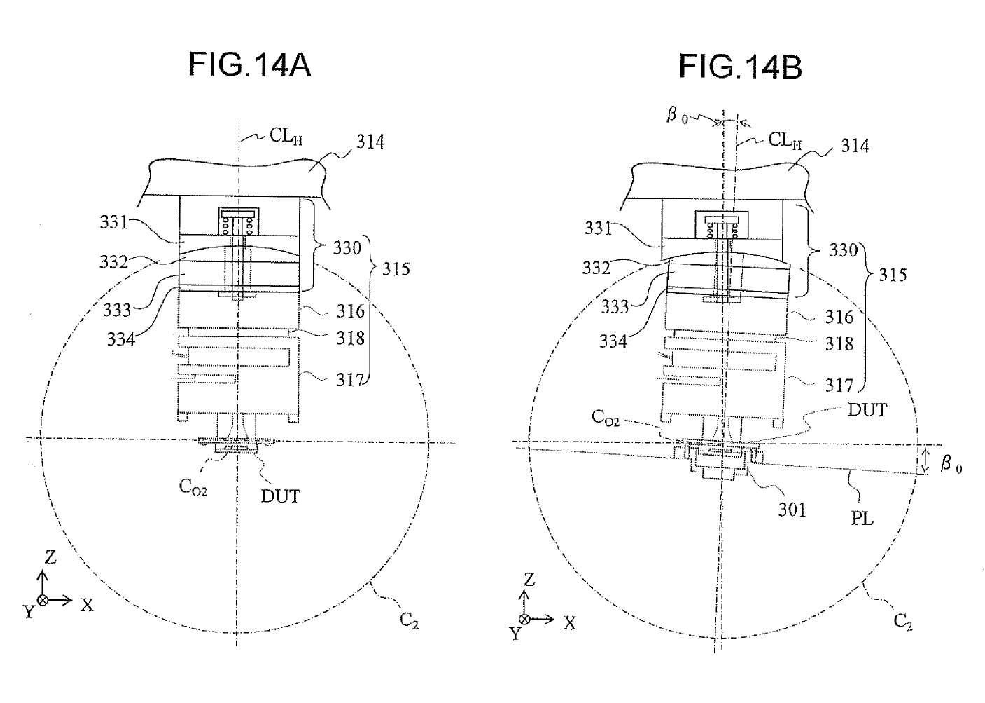

The concave arcuate shape 331a of the Y-axial rotation receiving member 331 and the first convex arcuate shape 332a of the first Y-axial rotating member 332 are set, to enable rotation of the center of an image sensor DUT, so that, as shown in FIG. 14A and FIG. 14B, the center C_{C2} of the circle C₂ of the extension of these arcuate shapes substantially matches the center position of the image sensor DUT.

The first through hole 331b of the Y-axial rotation receiving member 331 has a diameter smaller than the inside diameter of the spring 337. A spring 337 can be interposed between the bolt 335 inserted in the through hole 331b and the Y-axial rotation receiving member 331.

To smooth the sliding operation between the Y-axial rotation receiving member 331 and the Y-axial rotating member 332, a flexible spacer 332c comprised of for example Teflon® or another synthetic resin and a plurality of bearings 332d are provided. The spacer 332c is formed at its approximate center with third through hole 332e for passing a bolt 335.

As shown in FIG. 12, the Y-axial rotating member 332 is formed or its top surface with a plurality of grooves 332f running along the peripheral direction of the first convex arcuate shape 332a. Further, the spacer 332c is formed with a plurality of small diameter holes 332g into which a plurality of bearings 332d are inserted at positions corresponding to the plurality of grooves 332 formed in the Y-axial rotating member 332. Further, the Y-axial rotation receiving member 331 is formed at its bottom surface with a plurality of grooves 331c at positions facing the plurality of grooves 332f of the Y-axial rotating member 332.

Further, when mating the arcuate shapes 331a and 332a of the Y-axial rotation receiving member 331 and Y-axial rotating member 332, the plurality of bearings 332d inserted into the small diameter holes 332g of the spacer 332c are interposed between the grooves 331c of the Y-axial rotation receiving member 331 and the grooves 332f of the Y-axial rotating member 332. By the bearings 332d turning along the grooves 332f, the Y-axial rotating member 332 smoothly slides wish respect to the Y-axial rotation receiving member 331. In the above-mentioned way, the first arcuate shapes 331a, 332a of these members 331, 332 match in their center of rotation C_{O2} with the center of the image sensor DUT, so the above sliding operation results in β rotation of the image sensor DUT about the Y-axis.

As shown in FIG. 12, the Y-axial rotating member 332 is provided at its bottom surface with an X-axial rotation receiving member 333. This X-axial rotation receiving member 333 is formed at its bottom surface with a second concave arcuate shape 333a running along the peripheral direction about the X-axis and is formed at its approximate center with a fourth through hole 333b through which a bolt 335 passes. As opposed to this, the X-axial rotating member 334 is formed at its top surface with a second convex arcuate shape 334a of a shape corresponding to the second concave arcuate shape 333a of the X-axial rotation receiving member 333 and is formed at its approximate center with a fifth through hole 334b through which a bolt 335 passes.

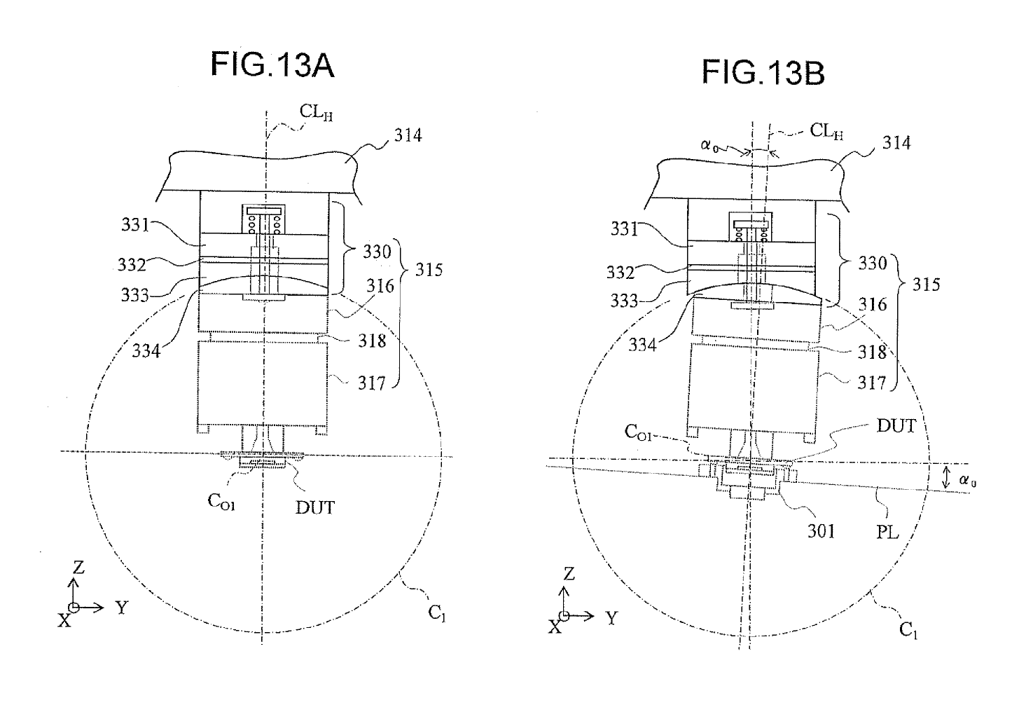

The second concave arcuate shape 333a of the X-axial rotation receive no member 333 and the second convex arcuate shape 334a of the X-axial rotating member 334 are set, to enable rotation of the center of an image sensor DUT, so that, as shown in FIG. 13A and FIG. 13B, the center C_{O1} of the circle C₁ of the extension of these arcuate shapes substantially matches the center position of the image sensor DUT.

To facilitate the sliding operation, a flexible spacer 334c made of for example Teflon® or another synthetic resin and a plurality of bearings 334d are provided between the X-axial rotation receiving member 333 and the X-axial rotating member 334. The spacer 334c is formed at its approximate center with a sixth through hole 334e for passage of a bolt 335.

As shown in FIG. 12, the X-axial rotating member 334 is formed on its top surface with a plurality of grooves 334f along the peripheral direction of the second convex arcuate shape 334a. Further, the spacer 334c is formed with a plurality of small diameter holes 334g into which a plurality of bearings 334d are inserted at positions corresponding to the plurality of grooves 334f formed in the X-axial rotating member 334. Further, the X-axial rotation receiving member 333 is formed at its bottom surface with a plurality of grooves 333c at positions facing the plurality of grooves 334f of the X-axial rotating member 334.

Further, when mating the arcuate shapes 333a and 334a of the X-axial rotation receiving member 333 and X-axial rotating member 334, the plurality of bearings 334d inserted into the small diameter holes 334g of the spacer 334c are interposed between the grooves 333c of the X-axial rotation receiving member 333 and the grooves 334f of the X-axial rotating member 334. By the bearings 334d turning along the grooves 334f, the X-axial rotating member 334 smoothly slides with respect to the N-axial rotation receiving member 333. In the above-mentioned way, the second arcuate shapes 333a, 334a of these members 333, 334 match in their center of rotation C_{O1} with the center of the image sensor CUT, so the above sliding operation results in a rotation of the image sensor DUT about the X-axis.

The thus configured tilting mechanism 330 is provided at the contact arm 315 with the top surface of the root side arm 316 attached to the bottom surface of the X rotating member 334. Note that this tilting mechanism 330 may also be provided between the lock-and-free mechanism 318 and the holding side arm 317. Further, in the present embodiment, the Y-axial rotating member 332 and the X axial rotation receiving member 333 are comprised of separate independent members fastened to each other by for example bolting or another method, but this is based on working restrictions. The invention is not limited to this. The Y-axial rotating member 332 and the X-axial rotation receiving member 333 may be integrally formed.

The thus configured members 331, 332, 333, and 334 are joined with their first arcuate shapes 331a, 332b and their second arcuate shapes 333b, 334 with arc axes offset by 90 degrees. They are assembled together by interposing a spring 337 at the top surface of the Y-axial rotation receiving member 321, inserting the bolt 335 through the through holes 331b, 332b, 333b, and 334b, and fastening them by a nut 336 at the bottom surface of the X-axial rotating member 334. Note that the bolt 335 sticks out from the top surface of the Y-axial rotation receiving member 331 to an extent enabling it to impart sufficient elastic force to the spring 337.

Further, at the top surface of the Y-axial rotation receiving member 331, a linking member 338 formed with an inside space of a size sufficient for holding the bolt 335 and spring 337 sticking out from the top surface of the Y-axial rotation receiving member 331 is attached by for example bolting etc. to the Y-axial rotation receiving member 331. Further, this linking member 332 is attached by for example bolting etc. to the root part 340 of the movable head 312, and the contact arm 315 is linked with the movable head 312.

Explaining the tilting operation by a rotation of this tilting mechanism 330 about the X-axis, as shown in FIG. 13A, in the state where an image sensor DUT does not contact the contact part 301 such as for example before running a test, no external force is applied to the image sensor DUT, so the elastic force of the spring 337 causes the X-axial rotating member 334 to be axially aligned with the X-axial rotation receiving member 333 for centering. In this state, the centerline CL of the holding side arm 317 matches with the vertical direction (Z-axial direction in FIG. 13A and FIG. 13B).

As opposed to this, as shown in FIG. 13B, at the time of running the test, if the image sensor DUT contacts the contact part 301 on a α₀° inclined plane PL, the X-axial rotating member 334 slides relative to the X-axial rotation receiving member 333 in a direction substantially parallel to the pushing force at the time of contact. Due to this sliding operation, the root side arm 316, lock-and-free mechanism 318, and holding side arm 317 attached to the X-axial rotating member 334 rotate about the center position C_{O1} of the image sensor DUT and the image sensor PUT is tilted with respect to the inclined contact part 301. In this state, the centerline CL_{H} of the holding side arm 317 is inclined by α₀° with respect to the vertical direction. Further, in this state, the spring 337 is compressed by the sliding operation of the X-axial rotating member 334. When the image sensor DUT and the contact part 301 are in a non contact state after running the test, the spring 337 elongates due to the elastic force and the X-axial rotating member 334 is centered, that is, is returned to the origin.

Next, explaining the tilting operation by β rotation centered about the Y-axis of this tilting mechanism 330, as shown in FIG. 14A, in the state with an image sensor DUT not contacting the contact part 301 like before running the test, in the same way as the above FIG. 13A, no external force is applied to the image sensor DUT so the elastic force of the spring 337 causes the Y-axial rotating member 332 to be axially aligned with the Y-axial rotation receiving member 331 for centering. In this state, the centerline CL of the holding side arm 317 matches with the vertical direction (Z-axial direction in FIG. 14A, FIG. 14B).

As opposed to this, as shown in FIG. 14B, when an image sensor DUT contacts the contact part 301 on a β₀° inclined plane PL at the time of running a test, the Y-axial rotating member 332, slides relative to the Y-axial rotation receiving member 331 in a direction substantially parallel to the pushing force at the time of contact. Due to this sliding operation, the Y-axial rotating member 332 and the attached X-axial rotation receiving member 333, X-axial rotating member 334, root side arm 316, lock-and-free mechanism 318, and holding side arm 317 rotate about the center position C_{O2} of the image sensor DUT and the image sensor DUT is tilted to match with the inclined contact part 301. In this state, the centerline CL_{H} of the holding side arm 317 is inclined by β₀° with respect to the vertical direction. Further, in this state, the spring 337 is compressed by the sliding operation of the Y-axial rotating member 332. When the image sensor DUT and the contact part 301 enter a noncontact state after running the test, the spring 337 extends due to the elastic force and the Y-axial rotating member 332 is centered.

When an image sensor DUT contacts the contact part 30a on a plane PL inclined about the X-axis by α₀° and about the Y-axis by β₀°, the Y-axial rotating member 332 slides relative to the Y-axial rotation receiving member 331 and the X-axial rotating member 334 slides relative to the X-axial rotation receiving member 333 attached to the sliding Y-axial rotating member 332 so that the image sensor DUT is tilted to match with the plane substantially parallel to she contact part 301.

Each alignment system 320 in the test unit 30 of the image sensor test apparatus 1 according to the present embodiment is a means for aligning the positions of the holding side arms 317 so as to align the positions of the image sensors DUT. As shown in FIG. 2, in the present embodiment, a set of two alignment systems 320 are provided for one movable head 312 and therefore a total of two sets, that is, four, alignment systems 320 are provided in the handler 10. Therefore, among the four image sensors DUT held at one movable head 312, the positions of two image sensors DUT are aligned simultaneously. As a result, two alignment operations are performed to align the four image sensors DUT.

For example, by having one movable head 312 of the YZ conveyor system 310 execute a test and during this having the other movable head 312 align the positions of the two image sensors DUT of the second column and first row and the second column and second row, then align the positions of the two image sensors DUT of the first column and first row and the first column and second row by one set of two alignment systems 320, it is possible to efficiently supply aligned image sensors DUT to the test head 300 and raise the operating rate of the test head 300. Note that the number of alignment systems in the present invention is not particularly limited to the above number and may be suitably set from the time required for alignment of the image sensors, the time required for testing the image sensors, the number of contact parts, etc.

Each alignment system 320, as shown in FIG. 5, is comprised of a movable stage 321, a drive unit 322, a sensor side light 323r a reflection mirror 324 (reflecting means), a camera side light 325, and a first camera 326 (first image capturing means).

The first camera 326 of the alignment system 320 is a CCD camera for capturing images of image sensors DUT from the light receiving surface sides when aligning the positions of the image sensors DOT.

This first camera 326 is provided so that light along the optical axis OL_{c} of the camera 326 is reflected at the reflection mirror 324 and directed toward the Z-axis positive direction. In this way, by providing the reflection mirror 324 on the optical axis OL_{C} of the first camera 326, the first camera 326 can be set horizontal with respect to the body 12 and the height of the handler 10 itself can be kept low.

Further, a ring shaped sensor side light 323 and a similar ring shaped camera side light 325 are provided on the optical axis OL_{c} of this first camera 326 so as not to block the progression of light along the optical axis OL_{c} and to enable the first camera 326 to view all of the input and output terminals HB of the image sensors DUT. Due to this, sufficient luminance for enabling the input and output terminals HB of the image sensor DUT to be viewed by the first camera 326 can be secured.

Note that this first camera 326 and the second CCD camera 312b are calibrated with each other at the time of production of the handler 10.

As the specific method of this calibration, for example, a transparent calibration gauge having the shape of the image sensors DUT and drawn with XY coordinate axes is placed at an alignment system 320 so that it can be seen by the first camera 326, an image of this gauge is captured by the first CCD camera 326, and the XY coordinate axes drawn on the calibration gauge and its center position are read. Next, the second camera 312b is positioned above the gauge, an image of this gauge is captured by the second camera 312b, and the XY coordinate axes and center position of the calibration gauge are read. The XY coordinate axes of this calibration gauge become the reference XY coordinate system between the two cameras 326 and 312b.

Above the sensor side light 323 of the alignment system 320, a movable stage 321 having a first opening 321a is provided. The first opening 321a formed at this movable stage 321 has a size sufficient for an image sensor DUT to pass and has a size net passing the abutting member 317d provided at the bottom end of the holding since arm 317 of the movable head 312. Further, this movable stage 321 is set so that this first opening 321a does not block the progression of light along the optical axis OL_{c} and the first camera 326 can view at least all of the input and output terminals KB of the image sensor DUT.

This movable stage 321 is attached through stage support members 321b to a movable flat surface 3224 (explained later) of the drive unit 322 and is able to move in the X-axis and Y-axial directions and rotate by θ about the Z-axis. The stage support member 321b is formed with a second opening 321c of a size not blocking progression of light along the optical axis OL_{c} of the first camera 326 and enabling the first camera 326 to view at least all input and output terminals HB of the image sensor CUT.

Note that, the sensor side illumination 323, reflection mirror 324, camera side light 325, and first camera 326 are kept from being moved due to the drive operation of the drive unit 322 by being separately and independently supported by the body 12 side of the handler 10 from the movable stage 321, stage support member 321b, and movable flat surface 3224. As opposed to this, the holding side arm 317 holding an image sensor DUT tracks the drive operation of the drive unit 322 in the state with she lock-and-free mechanism 318 in the free state and with the Z-axial actuator 313 of the movable head 312 giving a predetermined pressure to the movable stage 321 and can move in the X-axial and Y-axial directions and rotate by θ rotation about the Z-axis.

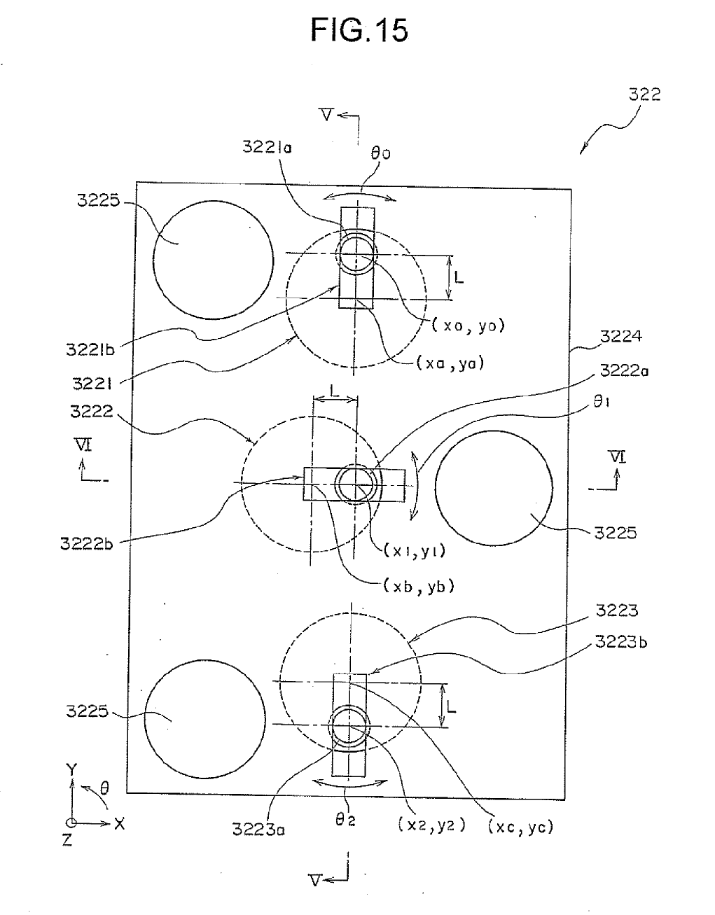

The drive unit 322 of the alignment system 322, as shown in FIG. 15, is a means for moving the movable stage 321 on the XY plane in the X-axial and Y-axial directions and for θ rotation about the Z-axis and is comprised of three drive motors 3221, 3222, and 3223, a movable flat surface 3224, flat surface support members 3225, and a board 3226.

Three drive motors 3221, 3222, and 3223 are provided on the board 3226. The first drive motor 3221 has a first eccentric shaft 3221a. The center (x₀, y₀) at the eccentric side of the first eccentric shaft 3221a is at a position a distance L from the center (xₐ, yₐ) of the drive shaft of the first drive motor 3221.

Similarly, the second drive motor 3222 has a second eccentric shaft 3222a. The center (x₁, y₁) at she eccentric side of the second eccentric shaft 3222a is at a position a distance L from the center (x_{b}, y_{b}) of the drive shaft of the second drive motor 3222.

Similarly, the third drive motor 3223 has a third eccentric shaft 3223a. The center (x₂, y₂) at the eccentric side of the third eccentric shaft 3223a is at a position a distance L from the center (x_{c}, y_{c}) of the drive shaft of the third drive motor 3223.

The movable flat surface 3224 of this drive unit 322 is, for examples a rectangular shape plate member provided at its center wish a rectangular second opening 3222b having long sides in the X-axial direction. Further, this movable flat surface 3224 is provided at one end along the Y-axial direction with a rectangular first opening 3221b having long sides in the Y-axial direction. Further, the movable flat surface 3224 is provided as the other end along the Y-axial direction with a rectangular third opening 3223b having long sides in the Y-axial direction.

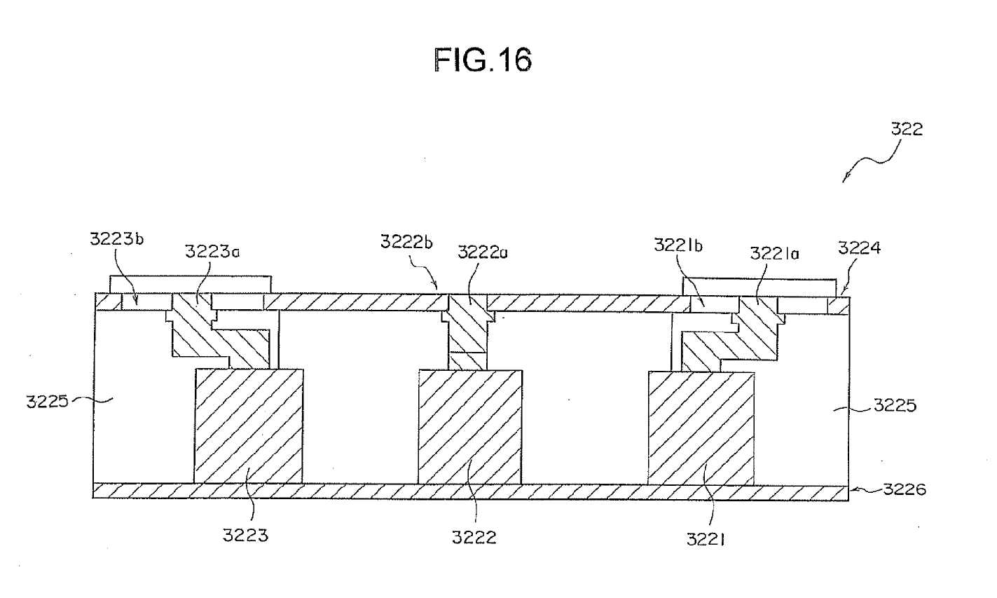

As will be understood from FIG. 16, at the center of the first opening 3221b, the first eccentric shaft 3221a of the first drive motor 3221 is inserted in a movable and rotatable manner.

Similarly, at the center of the second opening 3222b, the second eccentric shaft 3222a of the second drive motor 3222 is inserted in a movable and rotatable manner.

Similarly, at the center of the third opening 3223b, the third eccentric shaft 3223a of the third drive motor 3223 is inserted in a movable and rotatable manner.

In this way, by the insertion of the three eccentric shafts 3221a, 3222a, and 3223a in a movable and rotatable manner, movement of the movable flat surface 3224 in the X-Y plane becomes possible.

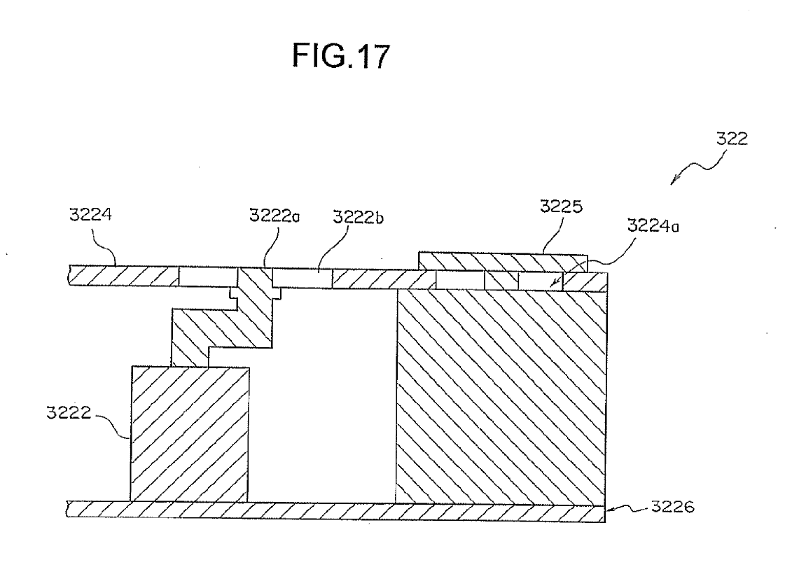

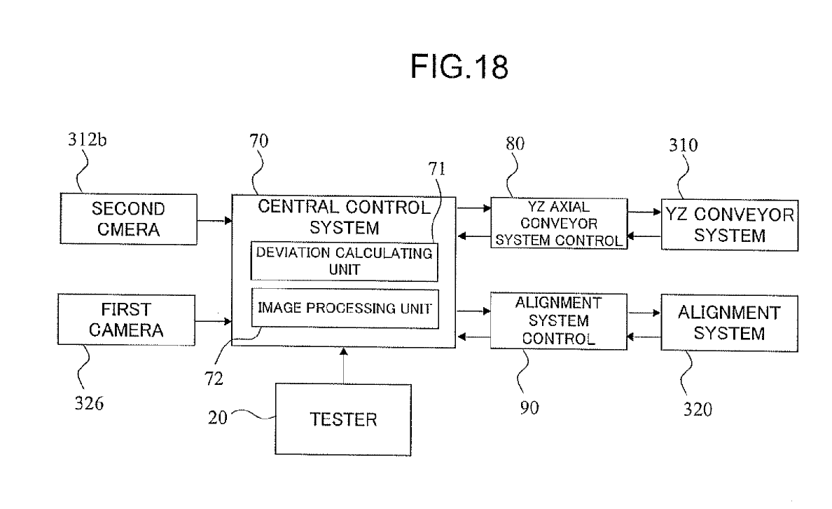

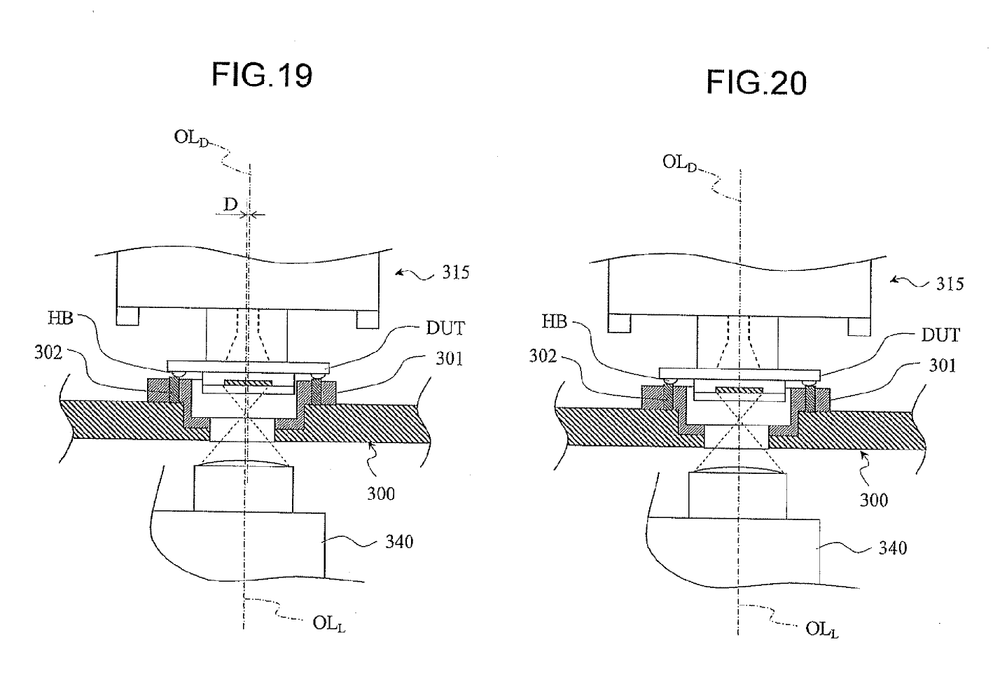

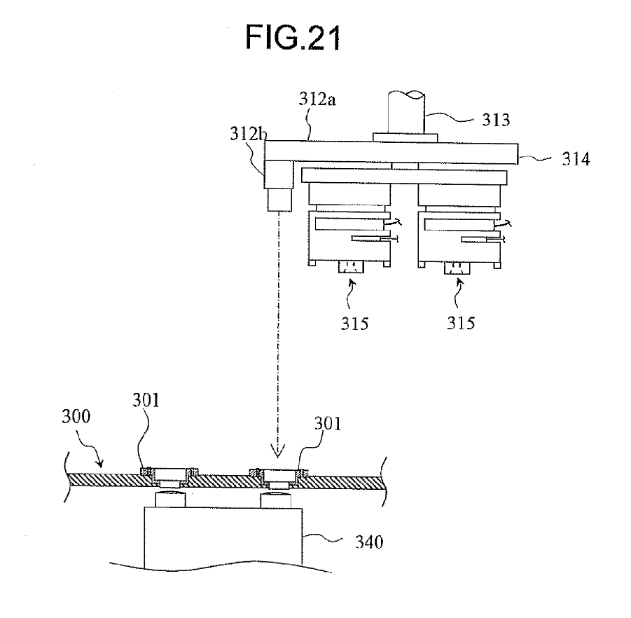

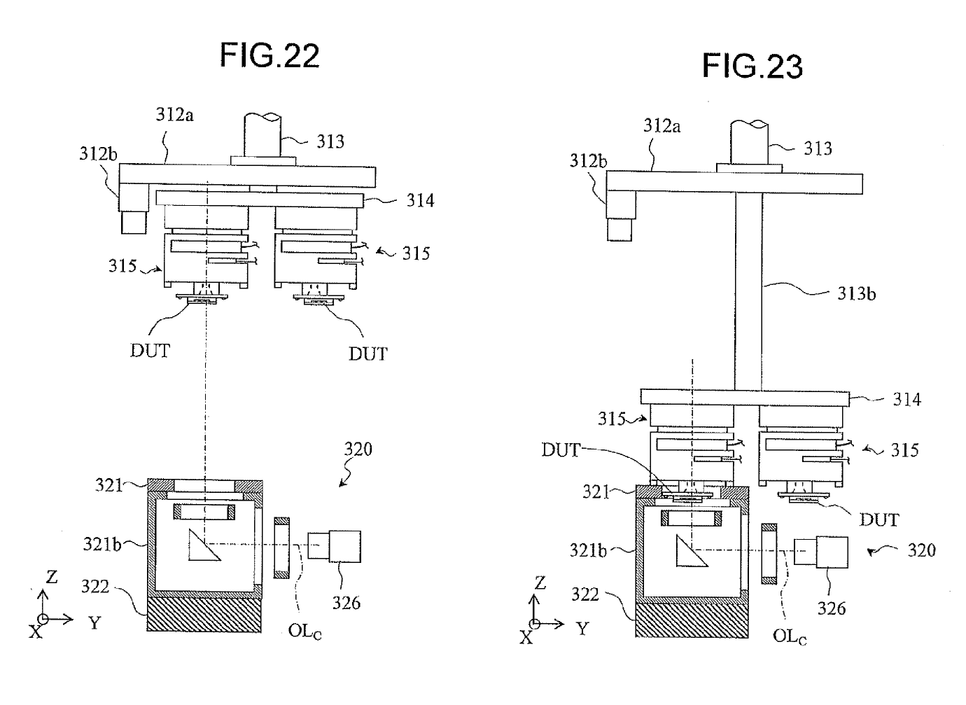

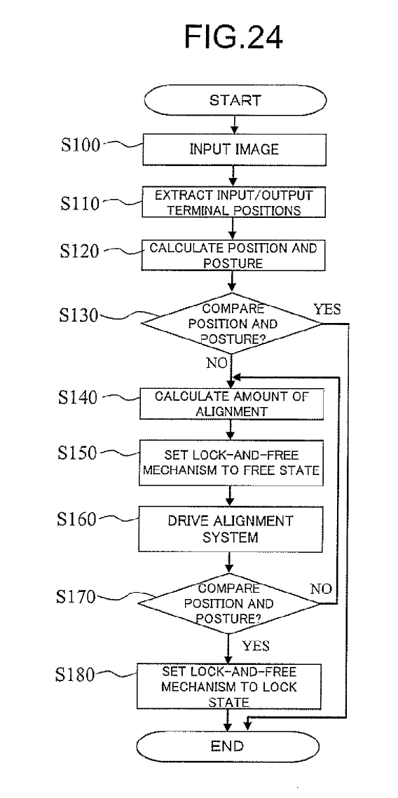

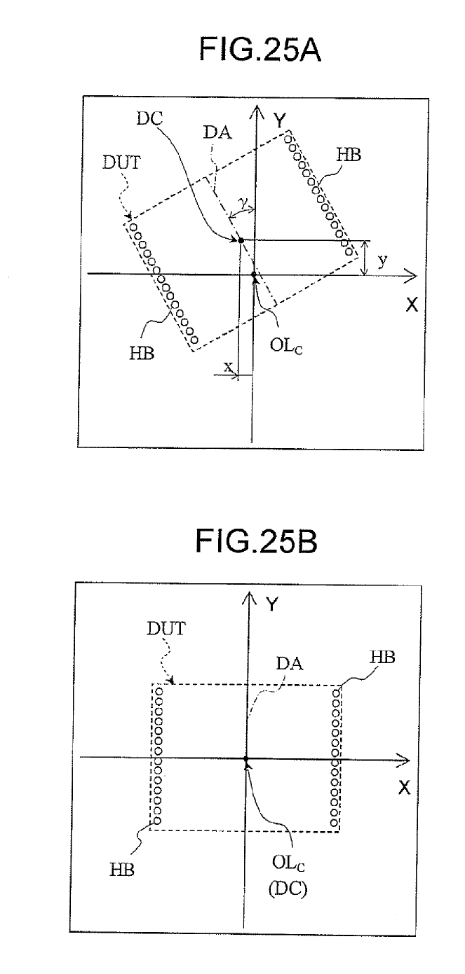

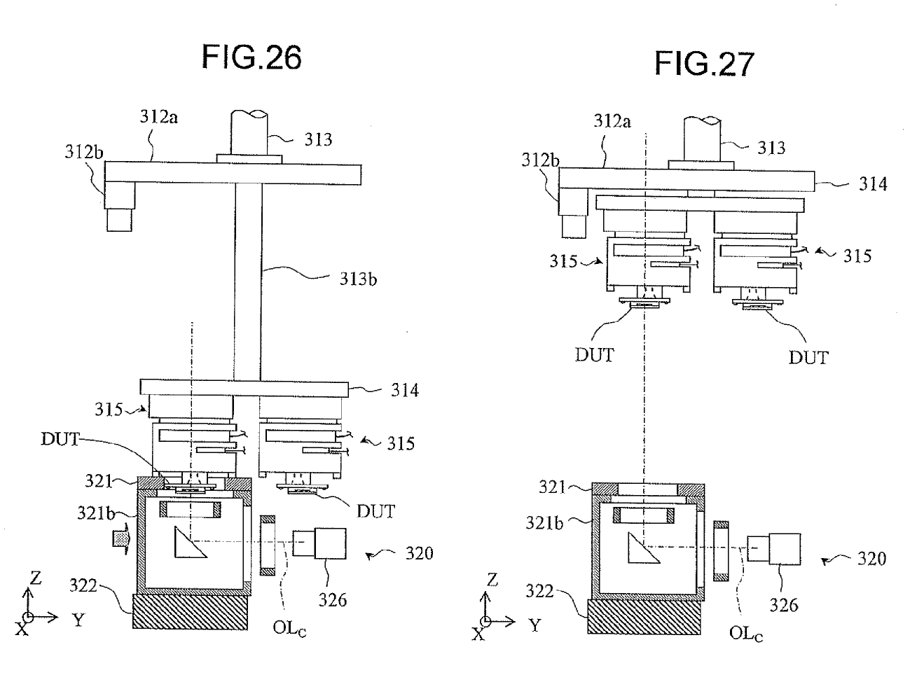

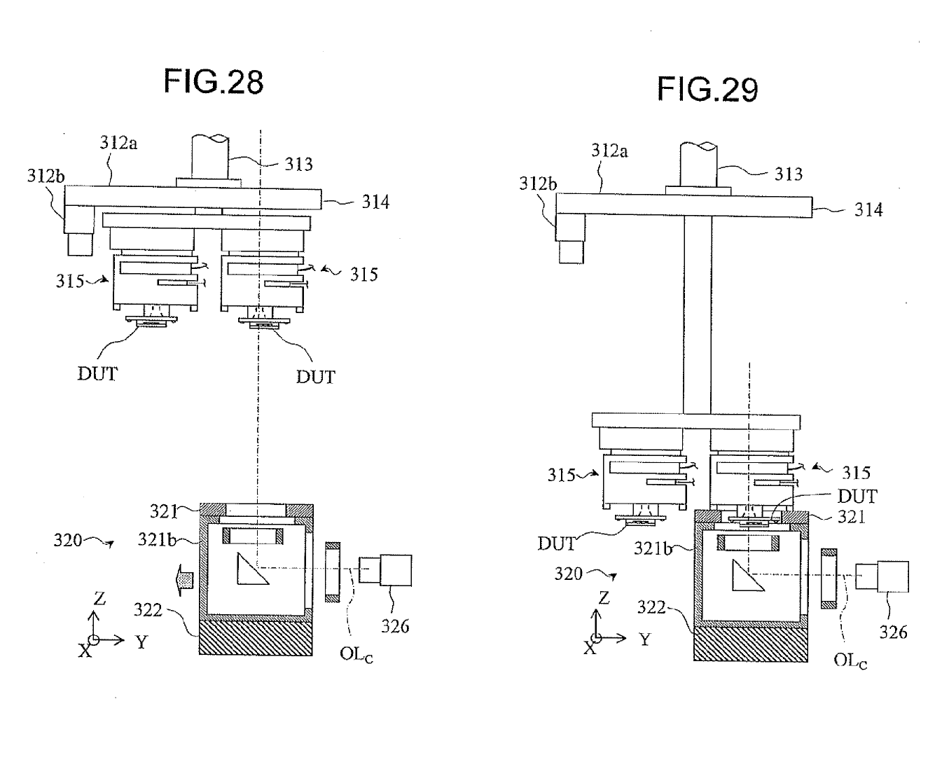

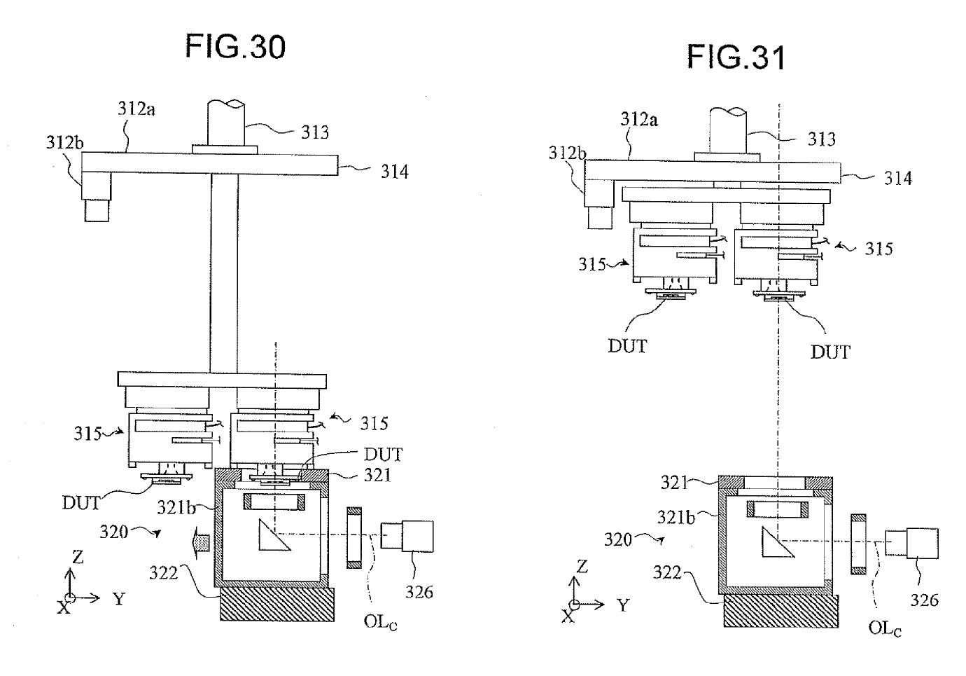

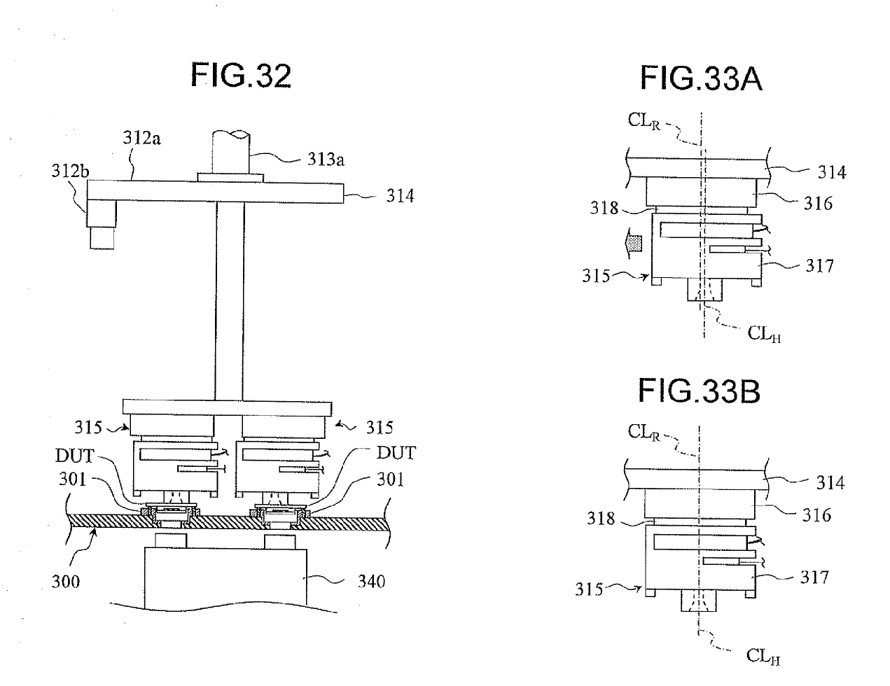

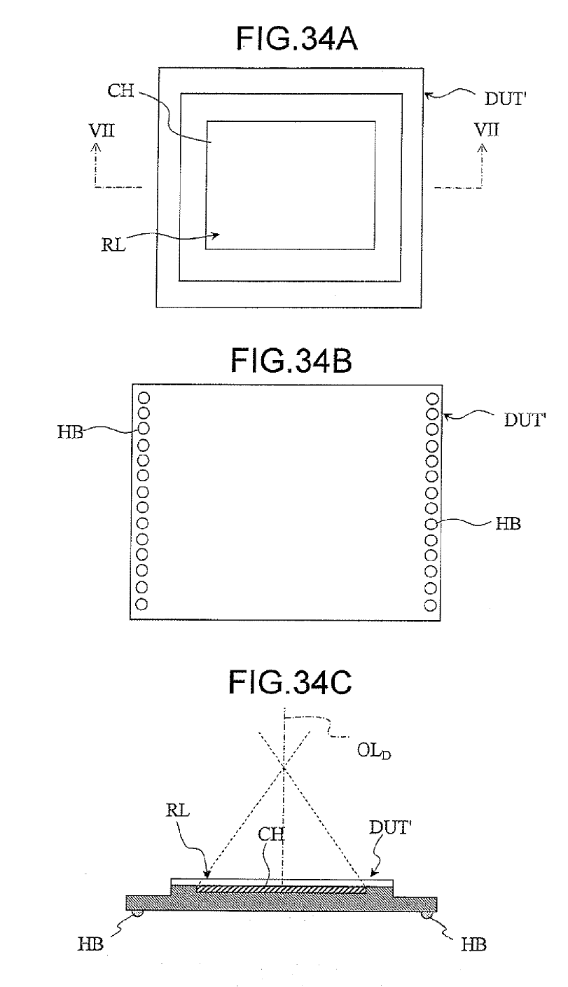

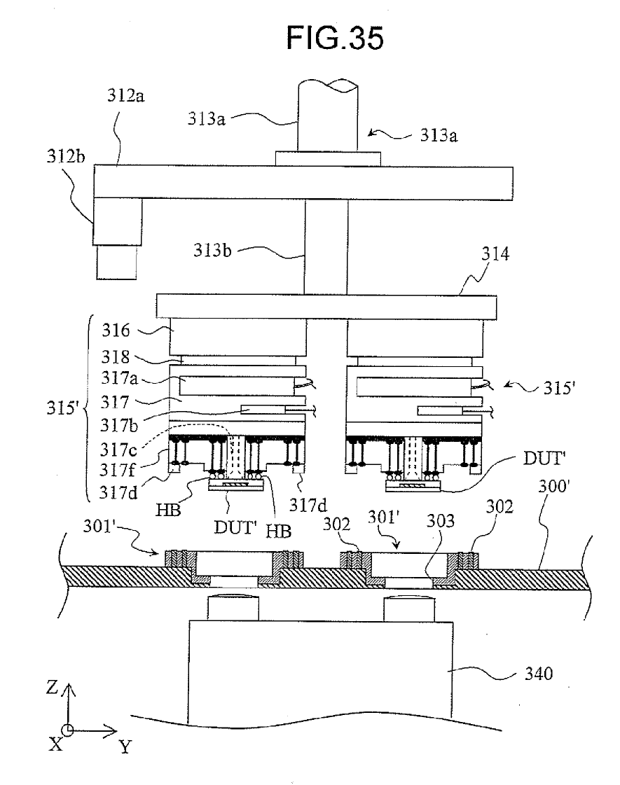

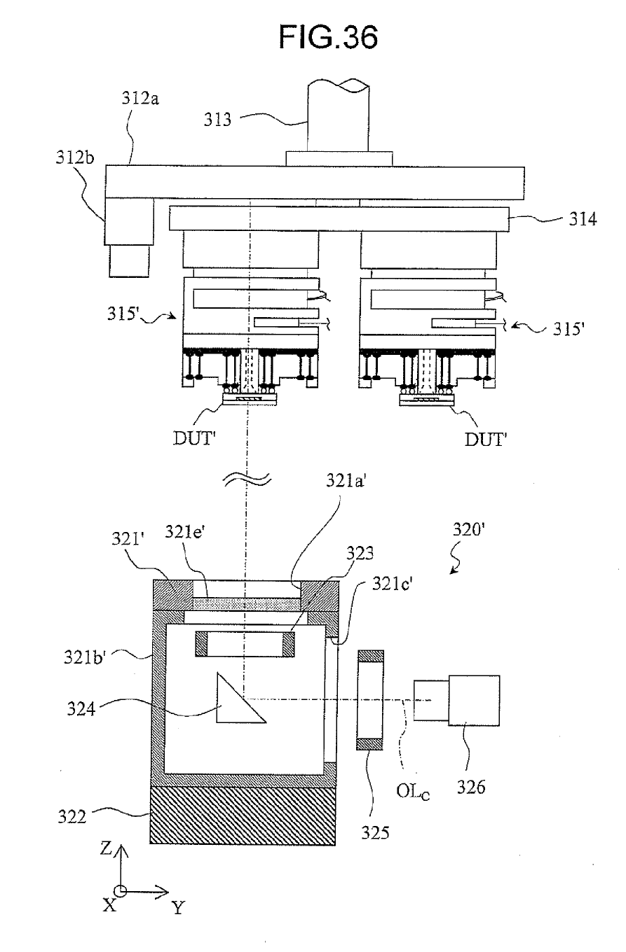

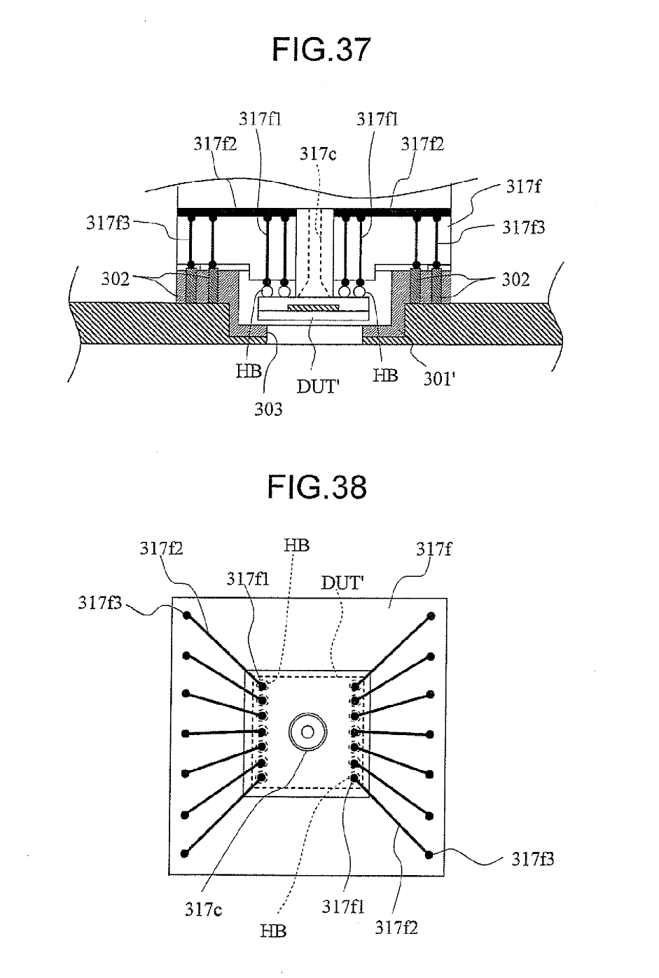

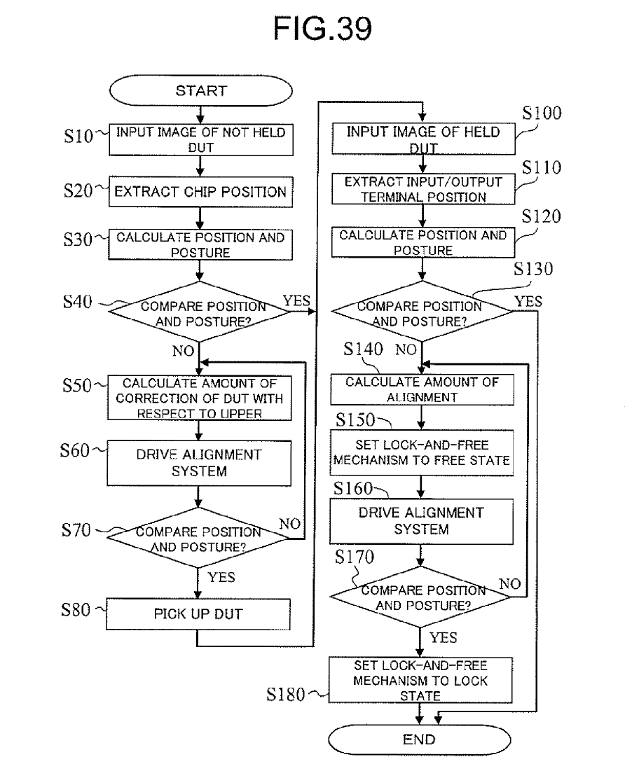

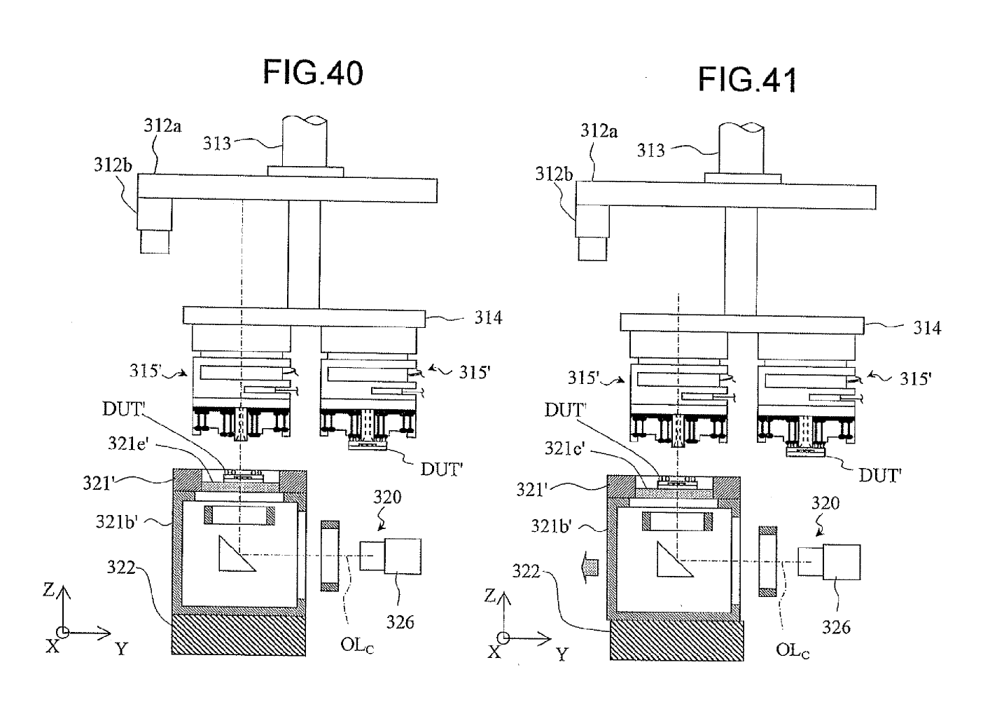

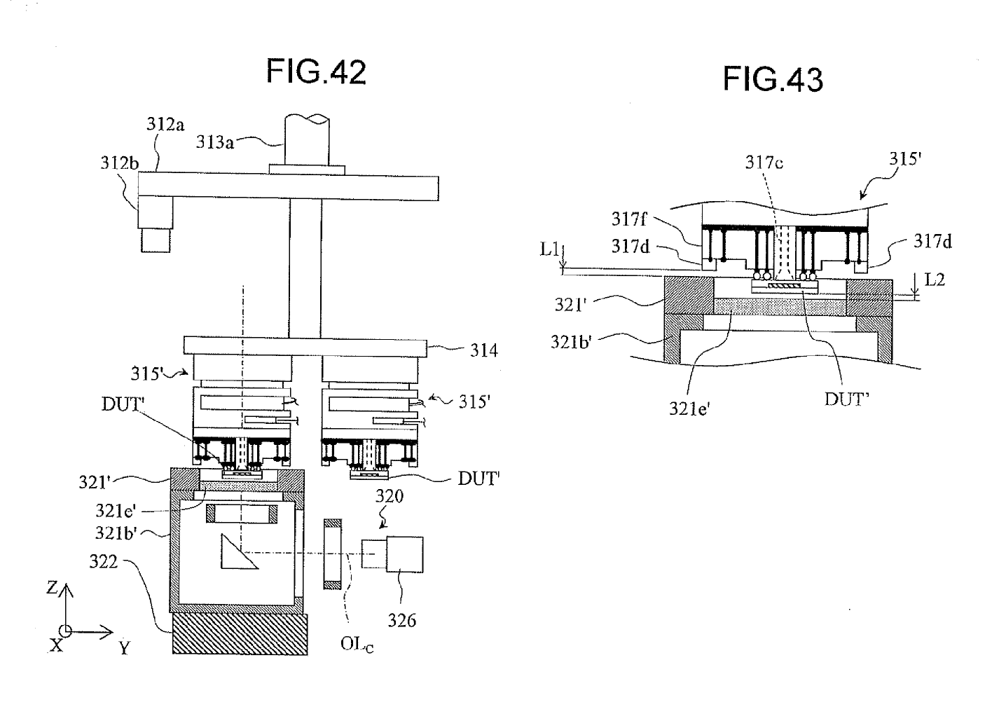

The flat surface support members 3225 of this drive unit 322 are members supporting the movable flat surface 3224 to enable X-Y-θ movement and are provided at three locations at the drive unit 322 shown in FIG. 15. As shown in FIG. 17, positions of the movable flat surface 3224 where the flat surface support members 3225 are provided are formed with support openings 3224a of circumferences smaller than the outer circumferences of the flat surface support members 3225, while the constricted parts of the flat surface support members 3225 are positioned at the openings 3224a. Due to this, the drive operations of the drive motors 3221, 3222, and 3223 enable stable support of the moving and rotating movable flat surface 3224.

In FIG. 15, when moving the movable flat surface 3224 of the drive unit 322 of the alignment system 320 in the X-axial positive direction, the first drive motor 3221 is driven to rotate in the −θ direction and the third drive motor 3223 is driven to rotate in the +θ direction. The second drive motor 3222 is not driven.

Further, when moving the movable flat surface 3224 in the X-axial negative direction, it is sufficient to drive the rotation of the first drive motor 3221 in the +θ direction and drive the rotation of the third drive motor 3223 in the −θ direction. In this case as well, the second drive motor 3222 is not driven.

In FIG. 15r when moving the movable flat surface 3224 of the drive unit 322 of the alignment system 320 in the Y-axial positive direction, the first drive motor 3221 and third drive motor 3223 need not be driven. It is sufficient to drive the rotation of only the second drive motor 3222 in the +θ direction.

Further, when moving the movable flat surface 3224 in the Y-axial negative direction, the first drive motor 3221 and third drive motor 3223 are not driven. It is sufficient to drive the rotation of only the second drive motor 3222 in the −θ direction.

In FIG. 15, when rotating the movable flat surface 3224 of the drive unit 322 of the alignment system 320 in the +θ direction about the second eccentric shaft 3222a, the first drive motor 3221 is driven to rotate in the +θ direction and the third drive motor 3223 is driven to rotate in the +θ direction. The second drive motor 3222 is not driven.

Further, when rotating the movable flat surface 3224 in the −θ direction about the second eccentric shaft 3222a, the first drive motor 3221 is driven to rotate in the −θ direction and the third drive motor 3223 is driven to rotate in the −θ direction. The second drive motor 3222 is not driver.

Note that by driving the rotation of the first drive motor 3221, second drive motor 3222, and third drive motor 3223 in accordance with the θ₀, θ₁, and θ₂ calculated by the following equations, the movable flat surface 3224 may be moved to the target position x, y and rotated at the target posture θ. Note that, the center of rotation at the target posture θ is the center (x₁, y₁) of the second eccentric shaft 3222a.

In the case of θ=0, the first drive motor 3221 should be made to drive the rotation of

$${θ}_{0} = {tan}^{- 3} ( \frac{- x / L}{\sqrt{1 - {( x / L )}^{2}}} )$$

the second drive motor 3222

$${θ}_{1} = {tan}^{- 1} ( \frac{y / L}{\sqrt{1 - {( y / L )}^{2}}} )$$

and the third drive motor 3223

$${θ}_{2} = {tan}^{- 2} ( \frac{x / L}{\sqrt{1 - {( x / L )}^{2}}} )$$

Further, when θ>0, the first drive motor 3221 should be made to drive the rotation of

$${θ}_{0} = {tan}^{- 3} ( \frac{a}{\sqrt{1 - {a}^{2}}} ) - θ$$

the second drive motor 3222

$${θ}_{1} = {tan}^{- 1} ( \frac{\sqrt{1 - {b}^{2}}}{b} ) + \frac{π}{2} - θ$$

and third drive motor 3223

$${θ}_{2} = - {tan}^{- 2} ( \frac{\sqrt{1 - {c}^{2}}}{c} ) - \frac{π}{2} - θ$$

Further, when θ<0, the first drive motor 3221 should be made to drive the rotation of

$${θ}_{0} = {tan}^{- 3} ( \frac{a}{\sqrt{1 - {a}^{2}}} ) - θ$$

the second drive motor 3222

$${θ}_{1} = {tan}^{- 1} ( \frac{\sqrt{1 - {b}^{2}}}{b} ) + \frac{π}{2} - θ$$

the third drive motor 3223

$${θ}_{2} = - {tan}^{- 2} ( \frac{\sqrt{1 - {c}^{2}}}{c} ) + \frac{π}{2} - θ$$

where, in the above equations, a, b, c, and n are

$$a = \frac{{x}_{a} - x + n \cdot y - n \cdot {y}_{a}}{L \cdot \sqrt{{n}^{2} + 1}}$$

$$b = \frac{{y}_{b} - y - n \cdot x - n \cdot {x}_{b}}{L \cdot \sqrt{{n}^{2} + 1}}$$

$$c = \frac{- {x}_{c} + x - n \cdot y + n \cdot {y}_{c}}{L \cdot \sqrt{{n}^{2} + 1}}$$

$$n = tan θ$$

Further, for example, in FIG. 15, when making the centers of the drive shafts of the three drive motors 3221, 3222, and 3223 (xₐ, yₐ)=(0, 50), (x_{b}, y_{b})=(−10, 0), and (x_{c}, y_{c})=(0, −50), to move the center of rotation θ of the movable flat surface 3224 from the center (x₁, y₁) of the second eccentric shaft=(0, 0) to (10, 10), it is possible to enter (xₐ, yₐ)=(−10, 40), (x_{b}, y_{b})=(−20, −10), (x_{c}, y_{c})=(−10, −60) into the above-mentioned equations to enable X-Y-θ movement about the center of rotation of the movable fiat surface 3224 as (10, 10).

By using the drive unit 322 of this alignment system 320, the positions of the holding side arms 317 holding the image sensors DUT can be moved and the alignment of the positions of the image sensors DUT is achieved.

The board 3226 supporting the three drive motors 3221, 3222, and 3223 of the drive unit 322 of this alignment system 320 is fixed to the body 12 side of the handler 10. Further, the movable flat surface 3224 is connected through the stage support member 321b to the movable stage 321 and, in the initial state shown in FIG. 15, is set so that the center of the center axis of the second drive shaft 2222 and the optical axis OL_{C} of the first camera 326 match.

Note that the first drive unit, second drive unit, and third drive unit referred to in the claims are functional expressions corresponding to X-axial direction operation, Y-axial direction operation, and θ rotation operation about the Z-axis in the above-mentioned movable flat surface 3224 and do not correspond to the first drive motor 3221, second drive motor 3222, and third drive motor 3223.

FIG. 18 is a block diagram showing the overall configuration of a control system of an image sensor test apparatus according to the first embodiment of the present invention.

Next, explaining the overall configuration of the control system in an image sensor test apparatus 1 according to the present embodiment, as show in FIG. 18, this apparatus is comprised of the first and second cameras 326, 312b, the tester 20, a central control system 71 having a deviation calculating unit 71 (calculating means) and an image processing unit 72 (image processing unit), a YZ conveyor system use control system 80 controlling the YZ conveyor system 310, and an alignment system use control system 90 controlling the alignment system 320.

The first and second cameras 326, 312b are able to transmit the captured image information to the central control system 70 by being connected to the central control system 70. Further, the central control system 70 can centrally control the image sensor test apparatus 1 as a whole by being connected to the tester 20, the YZ conveyor system use control system 80, and the alignment system use control system 90. In particular, it can receive the output signals acquired from the image sensors DUT at the time of a test from the tester 20.

As explained above, in a test of the image sensors, when the type of the image sensors is changed, a pretest must the run to align the optical axis OL_{O} of each image sensor DUT and the optical axis OL_{L} of each light source 340 so as to make the optical axis OL_{L} of the light source 310 coaxially match with the optical axis OL_{D} of the image sensor DUT after the change of the type in the state positioned above the light source 340.

As opposed to this, the deviation calculating unit 71 of the central control system 70 in the present embodiment receives output signals acquired by the tester 30 from an image sensors DUT in the pretest right after change of the type of the image sensors DUT, derives the distribution of the light striking the image sensor DUT from the received signals, and extracts the optical axis OL_{L} of the light source 340 from this distribution so can calculate the amount off deviation D of the optical axis OL_{D} of the image sensor DUT with respect to the optical axis OL_{L} of the light source 340 shown in FIG. 19.

The amount of deviation D calculated in this way is fed back to the main test after the pretest. Specifically, in the main test, when an alignment system 320 aligns the positions of image sensors DUT, the positions of the image sensors DUT are aligned considering the amounts of deviation D so that amounts of deviation D are cancelled. As shown in FIG. 20, at the time of the test, the optical axis OL_{L} of each light source 340 and the optical axis OL_{D} of the image sensor DUT substantially match, so a high precision test of the image sensors DUO can be performed.

The image processing unit 72 of the central control system 70 in the present embodiment has for example an image processing processor etc. and can processing the image information captured by the first camera 326 and second camera 312b, recognize the positions and postures of the contact parts 301 and image sensors DUT on the image, and calculate the amounts of alignment of the image sensors DUT.

Further, at the time of a change of type of the image sensors DUT, the image processing unit 72 processes the image information captured by the second camera 312b so as to extract the positions of the plurality of contact pins 302 of the contact parts 301 and calculates the center positions of the contact parts 301 and the XY coordinate axes at the contact parts 301 from the extracted positions so as to calculate the positions and postures of the contact parts 301 on the image captured by the CCD camera 312b. Due to this, it becomes possible to recognize the changes in the positions of the contact parts 301 caused by a change in the test head 300 etc.

Further, at the time of the main test, this image processing unit 72 processes the image information captured by the first camera 326 and recognizes the positions and postures of the image sensors DUT on the image. Further, it calculates the amounts of alignment in the X-axial and Y-axial directions and θ rotation about the Z-axis required for the image sensors DUT so as to make the positions and postures of the image sensors DUT on the image match the recognized positions and postures of the contact parts 301. Note that the coordinate systems on the images captured by the first camera 326 and second camera 312b are linked by calibration between the cameras 326, 312b as explained above.

The amounts of alignment calculated in this way are transmitted from the central control system 70 to the YZ conveyor system use control system 80 and alignment system use control system 90. The alignment system use control system 90 controls the actuators of the drive unit 322 of the alignment system 320 based on this transmitted amount of alignment whereby the positions of the image sensors DUT are aligned. At this time, as explained above, when the amounts of deviation D are determined in the pretest, the amounts of deviation D are added to the amounts of alignment transmitted from the central control system 70 to the alignment system use control system 90.

Unloader Unit 60

The unloader unit 60 is a means for ejecting tested image sensors CUT from the test unit 30 to the sensor storage unit 40 and is comprised of a second XYZ conveyor system 601 and two unloader buffers 602.

Each unloader buffer 602 is a means able to move back and forth between the range of operation of the YZ conveyor system 310 and the range of operation of the second XYZ conveyor system 601 and is comprised of a movable part 602a and an X-axial actuator 602b. A movable part 602a is supported at the front end of the X-axial actuator 602b fixed on the body 12 of the handler 10. The movable part 602a is formed at its top surface with four wells 602c in which the image sensors DUT can be dropped.

Further when the YZ conveyor system 310 drops tested image sensors DUT into the wells 602c of the movable part 602a of an unloader buffer 602 positioned in the range of operation of the YZ conveyor system 310, the unloader buffer 602 can retract the X-axial actuator 602b so as to move the movable part 602a in the range of operation of the second XYZ conveyor system 601.

Note that the movable part 602a need not be provided with the wells 602c. For example, the surface of the movable part 602a may also be made a flat surface provided with suction pads with suction surfaces facing vertically upward. In this case, the YZ conveyor system 310 places the image sensors DUT on the suction pads, picks up the image sensors DUT by the suction pads, retracts the X-axial actuator 602b, moves inside the range of operation of the second XYZ conveyor system 601, and, when finishing this, releases the suction of the suction pads, whereby the second XYZ conveyor system 601 holds the tested image sensors DUT.

By providing the unloader buffers 602 in this way, the second XYZ conveyor system 601 and the YZ conveyor system 310 can the simultaneously operated without interference with each other. Further, by providing two unloader buffers 602, it becomes possible to eject image sensors DUT from the test head 300 efficiently and improve the operating rate of the image sensor test apparatus 1. Note that, the present invention is not limited to two unloader buffers. The number may be suitably set from the time required for alignment of the image sensors, the time required for testing the image sensors DUT, etc.

The second XYZ conveyor system 601 is a means for moving and placing the image sensors BUT on an unloader buffer 602 to a classification tray of a classification tray stocker 402 and is comprised of Y-axial rails 601a, an X-axial rail 601b, a movable head 601c, and suction pads 601d and has a range of operation including two unloader buffers 602 and the classification tray stocker 402.

As shown in FIG. 2, the two Y-axial rails 601a of this second XYZ conveyor system 601 are fixed to the body 12 of the handler 10. Between them, the X-axial rail 601b is supported slidably in the Y-axial direction. Further, this X-axial rail 601b supports the movable head 60c provided with a Z-axial actuator (not shown) slidably in the X-axial direction. Further, this movable head 601c has tour suction pads 601d at its bottom by driving the thus prepared Z-axial actuator, it becomes possible to raise and lower the tour suction pads 601d in the Z-axial direction.

The second XYZ conveyor system 601 can position the four suction pads 601d above the image sensors DUT on an unloader buffer 602, pick up the four image sensors DUT at one time, move them above the classification tray of the classification tray stocker 402, position them, then release the image sensors DUT above the classification tray.

Below, FIG. 21 to FIG. 33B will be referred to so as to explain a method of testing image sensors BUT by the image sensor test apparatus 1 according to the present embodiment.

Note that the tests by the image sensor test apparatus 1 according to the present embodiment include not only the main test for actually testing the image sensors DUT, but also a pretest for the purpose of aligning the optical axis OL_{L} of each light source 340 and the optical axis OL_{D} of the image sensor DUT at the time of the change of type of the image sensors as explained above, but in the following explanation, the case of the pretest and the case of the main test will be explained together and only the parts differing in processing will be explained.

FIG. 21 is a view showing state of capturing an image of a contact part by a second camera when changing the type of device in the first embodiment of the present invention, FIG. 22 is a view showing the state of positioning two image sensors of the second column and first row and the second column and second row above the alignment system during an alignment operation by the image sensor test apparatus according to the first embodiment of the present invention, FIG. 23 is a view showing the state of insertion of an image sensor into the alignment system from the state of FIG. 22, FIG. 24 is a flowchart showing processing for alignment of the position of an image sensor in the first embodiment of the present invention, FIG. 25A is a view showing an example of an image of the state before alignment in the first embodiment of the present invention while FIG. 25B is a view showing an example of an image of the state after alignment of the first embodiment of the present invention, FIG. 26 is a view showing the state of the completion of the alignment of two image sensors of the second column and first row and the second column and second row from the state of FIG. 23, FIG. 27 is a view showing the state of four image sensors raised from the state of FIG. 26, FIG. 28 is a view showing the state of positioning the two image sensors of the first column and first row and first column and second row above the alignment system from the state of FIG. 27, FIG. 29 is a view showing the state of insertion of an image sensor in the alignment system from the state of FIG. 28, FIG. 30 is a view showing the state of the completion of alignment of the two image sensors of the first column and first row and the first column and second row from the state of FIG. 29, FIG. 31 is a view showing the state of four image sensors raised from the state of FIG. 30, FIG. 32 is a view showing the state of running tests on tour image sensors from the state of FIG. 31, and FIG. 33A and FIG. 33B are views showing a centering operation of the contact arm by the lock-and-free mechanism in the first embodiment of the present invention.

Nose that, FIG. 21 to FIG. 23 and FIG. 26 to FIG. 32 are schematic cross-sectional views of the test unit 30 seen toward the X-axial negative direction in FIG. 2. The movable head 312 illustrates the movable head 312 in the Y-axial positive direction in FIG. 2, while the alignment system 320 illustrates the set of two alignment systems 320 in the Y-axial positive direction in FIG. 2. Further, the image sensors DUT shown at the right in FIG. 21 to FIG. 23 and FIG. 25 to FIG. 32 show the image sensors DUT of the first column and first row and the first column and second row, while the image sensors DUT shown at the left in the figures show the image sensors DUT of the second column and first row and the second column and second row (same for contact arms 335). However, the image sensors DUT of the first column and first row and the second column and first row overlap with those of the first column and second row and the second column and second row, so are not shown. Another alignment system 320 is provided at the far side of the illustrated alignment system 320, but overlaps this system, so is not illustrated.

First, the first XYZ conveyor system 501 uses four suction pads 501d to pick up and hold four image sensors DUT on the feed tray positioned at the topmost level of a feed tray stocker 401 of the sensor storage unit 40.

Next, the first XYZ conveyor system 501, in the state holding the four image sensors DUT, uses the Z-axial actuator provided at the movable head 501c to raise the four image sensors DUT and slides the X-axial rail 501b on the Y-axial rails 501a and slides the movable head 501c on the X-axial rail 501b to move the loader unit 50. Further, the first XYZ conveyor system 501 positions the sensors above the wells 503a of the heat plate 503, extends the Z-axial actuator of the movable head 501S, and releases the suction of the suction pads 501d to drop the image sensors DUT in the wells 503a. The heat plate 503 heats the image sensors DUT to a predetermined temperature, then again the first XYZ conveyor system 501 holds the heated four image sensors DUT and moves them above one waiting loader buffer 502. Further, the first XYZ conveyor system 501 positions them above the movable part 502a of one waiting loader buffer 502, then extends the Z-axial actuator of the movable head 501c and releases the suction of the suction pads 501d so as to drop the four image sensors DUT in the wells 502c formed in the top surface of the movable part 502a.

Next, the loader buffer 502 extends the X-axial actuator 502b while holding the four image sensors DUT and moves the four image sensors CUT from the range of operation of the first XYZ conveyor system 501 of the loader unit 50 to the range of operation of the YZ conveyor system 310 of the test unit 30.

Note that, when the type of the image sensors DUT to be tested is changed, before or simultaneously with the above operations, as shown in FIG. 21, the test unit 30 moves a movable head 312 of the YZ conveyor system 310 over the contact parts 301 and uses the second camera 312b to capture the images of the contact parts 301. This image information captured by the second camera 312b is processed in the image processing unit 72 of the central control system 70 and the positions and postures of the contact parts 301 on the images are recognized from this image information.

Next, the Z-axial actuator 313 provided at the one of the movable heads 312 of the YZ conveyor system 310 positioned above the loader buffer 502 is extended and the four suction pads 317c provided at the movable head 312 are used to pick up and hold the four image sensors DUT positioned at the wells 502c of the movable part 502a of the loader buffer 502. At this time, the image sensors DUT are picked up by the suction pads 317c of the YZ conveyor system 310 at the surfaces opposite to the light receiving surfaces RL.

Next, the movable head 312 rises while holding the four image sensors DUT by the Z-axial actuator 313 provided at the movable head 312.

Next, as shown in FIG. 22, the YZ conveyor system 310 slides the X-axial direction support member 311a supporting one movable head 312 on the Y-axial rails 311 and positions the two holding side arms 317 of the second column and first row and second column and second row above an alignment system 320.

Next, as shown in FIG. 23, the movable head 312 extends the Z-axial actuator 313, whereby an image sensor DUT held by a holding side arm 317 is inserted into a first opening 321a formed in the movable stage 321 of the alignment system 320 and the abutting member 317d of the holding side arm 317 abuts against the movable stage 321 of the alignment system 320 and pushes against it by a predetermined pressure.

Next, at step S100 of FIG. 24, in the state with the Z-axial actuator 313 maintaining a predetermined pressure, the first camera 326 of the alignment system 320 captures the images of the two image sensors DUT at the second column and first row and second column and second row. The image information captured by the first camera 326 is sent to the image processing unit 72 of the central control system 70.

Next, at step S110 of FIG. 24, the image processing unit 72 of the central control system 70 extracts the positions of the input and output terminals HB of the image sensors DUT from the image information by image processing.

Next, at step S120 of FIG. 24, the image processing unit 72 calculates the sensor center position DC of each image sensor DUT and one of the coordinate axis DA of the XY coordinate axes in each image sensor DUT from the positions of the extracted input and output terminals HB and calculates the position and posture of each image sensor DUT on the image captured by the first camera 326. Note that the present invention is not limited to a method of calculating the position and posture of each image sensor DUT based on the input and output terminals HB and can also calculate them based on the chip of the image sensor DUT.

In this way, the image processing unit 72 recognizes the relative position of each image sensor DUT with respect to a contact part 301 based on the chip CH or input and output terminals HB of the image sensor DUT on the image information captured by the first camera 326, so poor contact can be prevented even when the package is deviated from the chip CH or input and output terminals HE in the image sensor DUT.

The method of calculation of one of the coordinate axes DA of an image sensor DUT, for example, comprises, at step S110, calculating approximation lines passing through the centers of the input and output terminals HB forming long columns in the extracted input and output terminals HB for each column and calculating the average line of the plurality of approximation lines. Note that the precision of the positions and postures of the image sensors DUT with respect to variations in the positions of the input and output terminals HB caused in production of the image sensors DUT may be improved by calculating another coordinate axis by a method similar to the method of calculation of the above one coordinate axis DA.

Here, when the test is a main test, at this step 3120, the amount or deviation D of the optical axis OL_{O} of each image sensor DUT with respect to the optical axis OL_{L} of each light source 340 is cancelled out by considering the amount of deviation D in calculation of the position and posture of the image sensor DUT.

As opposed to this, when the test is a pretest, the amount of deviation D after the change of type of the image sensors DUT is still not calculated, so the amount of deviation D is not considered in the calculation of the position and posture of each image sensor DUT.

In this way, in the alignment of the positions of the image sensors DUT, by considering the relative amount of deviation D of the optical axis OL_{D} of each image sensor DUT with respect to the optical axis OLL of each light source 340, it is possible to give the alignment system 320 for alignment of the positions of the contact arms 315 based on the relative positions of the image sensors DUT with respect to the contact parts 301 the function of aligning the optical axis OL_{L} of each light source 340 and the optical axis OL_{D} of each image sensor CUT and there is no longer a need to provide a fine adjustment function for each light source 340, so the image sensor test apparatus 1 can be reduced in size and the image sensor test apparatus 1 can be reduced in cost.

In particular, in the present embodiment, four image sensors DUT are simultaneously tested, so the light sources 340 can be arranged in proximity. Along with this, the pitch between the contact parts 301 can be reduced and the pitch between the contact arms 315 corresponding to these contact parts 301 can be reduced, so the image sensor test apparatus 1 can be made much smaller in size.

Further, along with the above narrowing of the pitch of the contact arms 315, the contact arms 315 themselves are reduced in weight, high speed movement of the YZ conveyor system 310 becomes possible, and poor contact of the contact parts 301 and the input and output terminals MB of the image sensors DUT can be prevented.

Next, at step S130 of FIG. 24, the image processing unit 72 compares the positions and postures of each contact part 301 on the image and the positions and postures of each image sensor DUT. In the comparison of this step S130, when the positions and postures match (YES at step S130), the alignment of the position of the image sensor DUT is ended.

Note that the positions and postures of the contact parts 301 on the image for comparison at this step S130 are captured by the second CCD camera 312b in advance at the time of change of type of the image sensors DUT. The positions and postures of the contact parts 301 on the image recognized by the image processing of the image processing unit 72 are linked with the positions and postures of the first camera 326 on the image. FIG. 25A shows an example of an image displaying the extracted input and output terminals HS of an image sensor DUT before alignment, the calculated sensor center position DC, and one coordinate axis DA of the image sensor DUT for convenience (same in FIG. 25B). Note that the center position and the XY coordinate axes of each contact part 301 or the image, for convenience in explanation, match the origin on the image, that is, the optical axis OL_{C} and the XY coordinate axes of the first camera 326.

When the positions and postures of the contact part 301 on the image do not match the positions and postures of the image sensor DUT (NO at step S130 of FIG. 24), at step S140 of FIG. 24, the image processing unit 72 calculates the amounts of alignment required for movement in the X-axial and Y-axial directions and θ rotation about the Z-axis to make the positions and postures of the image sensors DUT match she positions and postures of the contact parts 301.

For example, the amounts of alignment required in FIG. 25A are the +x motion in the X-axial direction, the −y motion in the Y-axial direct on, and −y rotation in the θ rotation direction about the Z-axis.

Next, at step S150 of FIG. 24, the central control system 70 sends to the YZ conveyor system use control system 80 an instruction for setting in the free state the lock-and-free mechanisms 318 holding the image sensors DUT of she second column and first row and the second column and second row. The YZ conveyor system use control system 80, based on this instruction, performs control for supplying air to the locking pistons 3183 of the lock-and-free mechanisms 318 and, after the lock-and-free mechanisms 318 are set in the free state, sends a completion signal to the central control system 70.

Note that, for example, when a recess 317e is formed at the abutting member 317d and a projection 321c is formed at the movable stage 321 in another embodiment of the present invention, the engagement between the recess 317e and projection 321c may be facilitated by setting each lock-and-free mechanism 318 in the free state before engagement.

Next, at step S160 of FIG. 24, the central control system 70 receives a completion signal from the YZ conveyor system use control system 80, then transmits the amounts of alignment calculated at step S140 to the alignment system use control system 90. Further, the alignment system use control system 90, as shown in FIG. 26, drives the first drive motor 3221, second drive motor 3222, and third drive motor 3223 of the drive unit 322 of the alignment system 320 based on the amounts of alignment for the alignment of the positions of the image sensors DUT. The alignment system use control system 90 transmits this completion signal to the central control system 70 when the drive operation is completed.

When the alignment by each alignment system 320 is completed, at step S170 of FIG. 24, the central control system 70 again compares the positions and postures of the image sensors DUT and the positions and postures of the contact parts 301 and, when not matching (NO at step S170), returns to step S140 and calculates the required amounts of alignment. Note that it is also possible not to perform the comparison at this step S170 and to proceed from step S160 to step S180. Due to this, it is possible to improve the processing speed of the flowchart shown in FIG. 24.

In the comparison of step S170 of FIG. 24, when it is judged that the positions and postures of the image sensors DUT and the positions and postures of the contact parts 301 match (YES at step S170), at step S180 of FIG. 24, the central control system 70 transmits an instruction for setting to a lock state the lock-and-free mechanisms 318 holding the image sensors DUT of the second column and first row and the second column and second row to the YZ conveyor system use control system 80. The YZ conveyor system use control system 80 performs control based on this instruction to supply air to the locking pistons 3183 of the lock-and-free mechanisms 318 and ends the alignment of the positions of the image sensors DUT. Note that the above alignment work is simultaneously executed by the two alignment systems 320 with respect to the two image sensors DOT of the second column and first cow and the second column and second row.

When the alignment of the positions of the image sensors DUT of the second column and first row and the second column and second row by the alignment systems 320 is completed, as shown in FIG. 27, the Z-axial actuator 313 of the movable head 312 raises the four image sensors DDT while they are held. The Z-axial actuator 313 is driven to move the image sensors DUT away from the alignment systems 320, then the drive unit 322 returns the movable stage 321 to the initial state.

Next, as shown in FIG. 23, the YZ conveyor system 310 moves the movable head 31 in the Y-axial negative direction by the pitch between the base side arm 316 of the first column and first row and the base side arm 316 of the second column and first row and positions the holding side arms 317 holding the two image sensors DUT of the first column and first row and the first column and second row finished being aligned above an alignment system 320.

Next, as shown in FIG. 29, the movable head 312 extends the Z-axial actuator 313 to insert an image sensor DUT held at a holding side arm 317 into a first opening 321a formed in the movable stage 321 of the alignment system 320, makes the abutting member 317d of the holding side arm 317 abut against the movable stage 321 of the alignment system 320, and pushes against it by a predetermined pressure.

Next, as shown in FIG. 30, in the state with the Z-axial actuator 313 maintaining a predetermined pressure, the central control system 70, the YZ conveyor system use control system 80, and the alignment system use control system 90 perform the processing of step S100 to step S180 of the flowchart of FIG. 24 and align the positions of the two image sensors DUT of the first column and first row and the first column and second row by an alignment system 320. Note that this alignment work is substantially simultaneously executed by the two alignment systems 320 with respect to the two image sensors DUT of the first column and first row and the first column and second row.

Here as well, when the test is a main test, at step S120 of FIG. 24, the amount of deviation D of the optical axis OL_{D} of each image sensor DUT with respect to the optical axis OL_{L} of each light source 340 is cancelled by considering the amount of deviation D in the calculation of the position and posture of the image sensor DUT.

As opposed to this, when the test is a pretest, the amount of deviation D after the change of type of the image sensors DUT is still not calculated, so the position and posture of each image sensor DUT are calculated without considering the amount of deviation D.

The alignment system 320 completes the alignment of the positions of the two image sensors DUT of the first column and first row and the first column and second row, then, as shown in FIG. 31, the Z-axial actuator 313 of the movable head 312 raises the four image sensors DUT while held. The Z-axial actuator 313 moves the image sensors DUT away from the alignment system 320, then the drive unit 322 returns the movable stage 321 to its initial state.

As explained above, the set of two alignment systems 320 aligns four image sensors DUT by a total of two operations.

Note that in the main test, while one movable head 312 of the YZ conveyor system 310 is aligning the four image sensors DUT, the other movable head 312 ruins the test at the test head 300 to thereby improve the operating rate of the image sensor test apparatus 1.

Next, the YZ conveyor system 310 slides the X-axial direction support member 311a supporting the movable head 312 on the Y-axial rails 311 and positions the four image sensors DUT held at the suction pads 317c of the front end of the movable head 312 above the four contact parts 301 of the test head 300.

Next, as shown in FIG. 32, the movable head 31.2 extends the Z-axial actuator 313 to make the input and output terminals HB of the four image sensors DUT contact the contact pins 302 of the four contact parts 301.

Further, by making the input and output terminals HB of the image sensors DUT contact the contact parts 301, simultaneously with this having the light sources 340 emit light to the light receiving surfaces RL of the image sensors DUT, and while doing so inputting and outputting electrical signals from the tester 20 from the contact parts 301 to the input and output terminals HB of the image sensors DUT, the tour image sensors DUT are simultaneously tested.

Here, where the test is a pretest, the deviation calculating unit 71 of the central control system 70 receives the output signals acquired by the tester 30 from each image sensor DUT at the time of the test, derives the distribution of the light striking the image sensor CUT from the output signals, and derives the optical axis OL_{L} of the light source 340 from the distribution of the striking light and thereby calculates the amount of deviation D of the optical axis OL_{D} of the image sensor DUT with respect to the optical axis OL_{L} of the light source 340 shown in FIG. 19. In this way, this amount of deviation D can be accurately determined by calculating the relative amount of deviation D of the optical axis OL_{D} of the image sensor DOT based on the electrical signals output from the image sensor DUT to which light is emitted from the light source 340.

As opposed to this, when the test is a main test, as explained above, in the alignment of the positions of the image sensors DUT, the amounts of deviation D are considered, so as shown in FIG. 20, the optical axis OL_{L} of each light source 340 and the optical axis OL_{D} of each image sensor DUT substantially match and a high precision test of the image sensors DUT can be executed.

When the four image sensors DUT finish being tested, the YZ conveyor system 310 uses the Z-axial actuator 213 provided at the movable head 312 to raise the tested four image sensors DUT while holding them, slides the X-axial direction support member 311a supporting the movable head 312 on the Y-axial rail 311, and positions the held four image sensors DDT above the movable part 602a of the unloader buffer 602 waiting in the range of operation of the YZ conveyor system 310.

Next, the movable head 312 extends the S-axial actuator 313 and releases the suction of the suction pads 317c so as to drop four image sensors DUT into the wells 602c formed in the top surface of the movable part 602a.

Note that, as shown in FIG. 33A and FIG. 33B, after ejecting the tested mage sensors CUT, the movable head 31 of the YZ conveyor system 310 stops supplying air to the locking pistons 3133 of the lock-and-free mechanisms 318 so as to make the centerlines CL_{H} of the holding side arms 317 match with the centerlines CL_{R} of the root side arms 316 so as to center the holding side contact arms 317.

Next, the unloader buffer 602 drives the X-axial actuator 602b while holding the tested four image sensors DUT and moves the image sensors DUT from the range of operation of the YZ conveyor system 310 of the test unit 30 to the range of operation of the second XYZ conveyor system 601 of the unloader unit 60.

Next, the Z-axial actuator provided at the movable part 602c of the second XYZ conveyor system 601 positioned above the unloader buffer 602 is extended and the four suction pads 601d provided at the movable part 602c pick up and hold the tested four image sensors DUT positioned in the wells 602c of the movable part 602a of the unloader buffer 602.

Next, the second XYZ conveyor system 601 raises the tested four image sensors DUT, while held, by the Z-axial actuator provided at the movable head 601c, slides the X-axial rail 601b on the Y-axial rails 601a, slides the movable head 601c on the X-axial rail 601b, and thereby moves the four image sensors DUT over a classification tray stocker 402 of the sensor storage unit 40. Here, the image sensors DUT are placed on the classification trays positioned at the topmost levels of the different classification tray stockers 402 in accordance with the test results of the image sensors DUT.

### Second Embodiment

FIG. 34A is a top plan view showing an image sensor under test of an image sensor test apparatus according to a second embodiment of the present invention, FIG. 34B is a lower plan view of the image sensor shown in FIG. 34A, and FIG. 34C is a cross-sectional view of the image sensor along the VII-VII line of FIG. 34A, FIG. 35 is a schematic cross-sectional view showing contact arms and a test head of the image sensor test apparatus according to the second embodiment of the present invention, FIG. 30 is a schematic cross-sectional view showing the contact arms and alignment systems of the image sensor test apparatus according to the second embodiment of the present invention, FIG. 37 is an enlarged schematic cross-sectional view of an upper contact of a contact arm shown in FIG. 35 and FIG. 36, and FIG. 38 is a plan view of the upper contact shown in FIG. 37.

First, explaining the image sensors to be tested in the second embodiment of the present invention, this image sensor DUT′, as shown in FIG. 34A to FIG. 34C, is a CCD sensor or CMOS sensor with a chip CH arranged at the approximate center part and with input and output terminals HB arranged at the outer circumference. It is similar to the image sensor DUT in the first embodiment, but differs from the image sensor DUT in the first embodiment in the point that the input and output terminals HB are led out to the opposite side of the light receiving surface RL where the micro lens is formed at the chip CH.

Along with this, in the image sensor test apparatus according to the second embodiment of the present invention, as shown in FIG. 35 and FIG. 36, the structure of the contact arms 315′ and the structure of the movable stages 321′ of the alignment systems 320′ differ from the image sensor test apparatus 1 according to the first embodiment, but the rest of the configuration is the same as the configuration of the configuration of the image sensor test apparatus 1 according to the first embodiment. Below, the image sensor test apparatus according to the second embodiment will be explained focusing on only the points of difference from the image sensor test apparatus according to the first embodiment.

The contact aims 315′ of the image sensor test apparatus according to the present embodiment differ from the contact arms 315 in the first embodiment in the point of being provided with upper contacts 317f for electrically connecting the input and output terminals HB of the above type of image sensors DUT′ to the contacts 301′.

Each upper contact 317f, as shown in FIG. 37 and FIG. 38, is comprised of sensor side connection lines 317f1 provided around the suction pad 317c and arranged corresponding to the input and output terminals HB of the image sensor DUT′, expansion use connection lines 317f2 electrically connected to the sensor side connection lines 317f2 and arranged to expand in pitch toward the outer circumference of the contact arm 315′, and contact side connection lines 317f3 electrically connected to the expansion use connection lines 317f2 and arranged corresponding to the contact pins 302 of the contact part 301′. The connection lines 317f1 to 317f3 are comprised of for example a metal material or other material excellent in conductivity.

An image sensor DUT′ of a type with input and output terminals HB led out to the opposite surface to the light receiving surface RL structurally cannot be directly brought into contact with the contact part 301′ at the time of a test. As opposed to this, in the image sensor test apparatus according to the present embodiment, by providing each contact arm 315′ with such an upper contact 317f, when the input and output terminals HB of the image sensor DUT′ picked up by the suction pads 317c of the contact arm 315′ contact the front ends of the sensor side connection lines 317f1 of the upper contact 317f and, as shown in FIG. 37, the contact pins 302 of the contact part 301′ are contacted by the front ends of the contact side connection lines 317f3 of the upper contact 317f, and the input and output terminals HB of the image sensor DUT′ and the contact pins 302 of the contact part 301′ are electrically connected through the sensor side connection lines 317f1, expansion use connection lines 317f2, and contact side connection lines 317f3.

Note that, in the image sensor test apparatus 1 according to the first embodiment, from the viewpoint of prevention of poor contact, the amount of deviation D of the optical axis OL_{D} of each image sensor DUT with respect to the optical axis OL_{L} of each light source 340 is not allowed unless not more than the diameter of the contact pins 302 of the contact parts 301, but in the image sensor test apparatus according to the present embodiment, as shown in FIG. 38, the pitch between the contact side connection lines 317f3 of the upper contact 3175 contacting the contact pins 302 becomes remarkably broader compared with the pitch between the input and output terminals HB of the image sensor DUT′. The diameter of the contact pins 302 of the contact parts 301 cannot be made greater, so a large amount of deviation D can be allowed.

The movable stage 321′ of each alignment system 320′ of the image sensor test apparatus according to the present embodiment, as shown in FIG. 36, positions the input and output terminals HB of each image sensor DUT′ with respect to the upper contact 317f by fitting a transparent carrying surface 321e′ comprised of for example glass, a synthetic resin, etc. in the first opening 321a′. It can capture the image of each image sensor DUT′ carried on this carrying surface 321e′ through the carrying surface 321e′ by the first camera 326 and can move the image sensor DUT′ carried on the carrying surface 321e′ on the XY plane in the X-axial and Y-axial directions and rotate it by θ about the Z-axis by drive operations of the drive unit 322. Note that it is also possible to embed suction lines etc. into this carrying surface 321e′ to reliably hold the carried image sensors DUT′.

Below, FIG. 39 to FIG. 43 will be referred to so as to explain a method of testing image sensors DUT by an image sensor test apparatus according to the present embodiment.

FIG. 39 is a flowchart showing the processing for alignment of the position of an image sensor in the second embodiment of the present invention, FIG. 40 is a view showing the state of a first camera capturing an image of an image sensor carried on a carrying surface of an alignment system in the second embodiment of the present invention, FIG. 41 is a view showing the state of positioning of an image sensor at an upper contact from the state of FIG. 40, FIG. 42 is a view showing a contact arm holding an image sensor positioned from the state of FIG. 41, and FIG. 43 is a detailed view showing the positional relationship of a contact arm, image sensor, and alignment system in the state of FIG. 42.

The method of testing image sensors DUT′ by an image sensor test apparatus according to the present embodiment differs from the method of testing image sensors DUT according to the image sensor test apparatus 1 according to the first embodiment in the point that, along with the input and output terminals HB of the image sensors DUT′ being led out to the opposite surfaces to the light receiving surfaces RL, provision is made of a step of positioning the image sensors DUT′ with respect to the upper contacts 317f of the contact arms 315′ (steps S10 to S80 at FIG. 39), but the other steps of the test method (steps S100 to S180 at FIG. 24 and FIG. 39) are similar to the test method in the first embodiment. Below, the method of testing image sensors DUT′ in a second embodiment will be explained focusing or only the points of difference with the test method in the first embodiment.

In the same way as the first embodiment, image sensors DUT′ given predetermined thermal stress through the heat plate 503 are supplied from the sensor storage unit 40 of the handler 10 by a loader buffer 502 to the test unit 30.

Image sensors DUT′ supplied to this test unit 30 are picked up and held by the contact arms 315′ of a movable head 312 of the YZ conveyor system 310 by suction pads 317c.

The four contact arms 315′ of each movable head 412 hold the image sensors DUT′, then position the two holding side arms 317 of the second column and first row and the second column and second row above the alignment system 320′.

Next, the movable head 312 extends the Z-axial actuator 313 and releases the suction of the suction pads 317c, whereby, as shown in FIG. 40, the image sensors DUT′ are placed on the carrying surface 321e′ of the movable stage 321 of the alignment system 320′.

Next, at step S10 of FIG. 39, the image of each image sensor DUT′ carried on the carrying surface 321e′ of the movable stage 321′ is captured by the first camera 326. The image information captured by the first camera 326 is transmitted to the image processing unit 72 of the central control system 70.

Next, at step 320 of FIG. 39, the image processing unit 72 of the central control system 70 extracts the position of the chip CH of the image sensor DUT′ by image processing from the image information and, at step S30 of FIG. 39, calculates the position and posture of the image sensor DUT′ based on the extracted position of the chip CH. Note that the present invention is not limited to only a method of calculating the positions and postures of the image sensors DUT′ based on the chips CH and may calculate them based on the outside shapes (packages) of the image sensors DUT′.

Next, at step 540 of FIG. 39, the image processing unit 72 compares the position and posture of each upper contact 317f on the image and the position and posture of each image sensor DUT′. In the comparison at this step S40, when the positions and postures match (YES at step S40), the positioning of the image sensors DUT′ with respect to the upper contacts 317f ends, then the routine proceeds to S100 of FIG. 39 where the positions of the image sensors DUT′ are aligned.

Note that the positions and postures of the upper contacts 317f on the image compared at this step S40 are calculated before the main test by the image sensor test apparatus is started by positioning the contact arms 315′ of each movable head 312 above the alignment system 320′, capturing an image of the upper contacts 317f in the state not holding the image sensors DUT′ by the first camera 326, and performing image processing by the image processing unit 72.

When the positions and postures of the upper contacts 317f on the image and the positions and postures of the image sensors DUT′ do not match (NO at step S40 of FIG. 39), at step S50 of FIG. 39, the image processing unit 72 calculates the amounts of correction required in the X-axial and Y-axial directions and θ rotation about the Z-axis so as to make the positions and postures of the image sensors DUT′ match the positions and postures of the upper contacts 317f.

Next, at step S60 of FIG. 39, the central control system 70 transmits the amounts of correction to the alignment system use control system 90. Further, the alignment system use control system 90, as shown in FIG. 41, drives the first drive motor 3221, second drive motor 3222, and third drive motor 3223 of the drive unit 322 of the alignment system 320′ based on the amounts of correction so as to position the image sensors DUT′ with respect to the upper contacts 317f. The alignment system use control system 90 transmits a completion signal to the central control system 70 when the drive operation is completed.

By recognizing the relative positions of the image sensors DUT′ with respect to the upper contacts 317f of the contact arms 315′ in this way and correcting the positions of the image sensors DUT′ based on this, it is possible to prevent poor contact even when testing image sensors DUT′ of a type with input and output terminals HB led out to the opposite surfaces from the light receiving surfaces RL.

Further, by driving the carrying surface 321e′ to position the image sensors DUT′ with respect to the upper contacts 317f by the drive unit 322 of each alignment system 320, there is no longer a need to provide a drive unit exclusively for driving the carrying surface 321e′, the image sensor test apparatus can be reduced in size and the cost or the image sensor test apparatus can be reduced.

When the alignment by each alignment system 320 is completed, at step S70 of FIG. 39, the central control system 70 again compares the positions and postures of the image sensors DUT′ and the positions and postures of the upper contacts 317f. When they do not match (NO at step S70), the routine returns to step S50 where the necessary amounts of correction are calculated. Note that it is also possible not to perform the comparison at this step 370 and proceed from step S60 to step S80. Due to this, it is possible to improve the processing speed of the flowchart shown in FIG. 39.

In the comparison of step S70 of FIG. 39, when judging that the positions and postures of the image sensors DUT′ and the positions and postures of the upper contacts 317f match (YES at step S70), at step S80 of FIG. 39, the central control system 70 sends the YZ conveyor system 310 an instructor to hold the positioned image sensors DUT′ by the contact arms 315′ of the movable head 312. The YZ conveyor system 310, based on this instruction, as shown in FIG. 42, extends the Z-axial actuator 313 to bring the contact arms 315′ close to the image sensors DUT′ and picks up and holds again the image sensors DUT′ by the suction pads 317c.

Note that due to the processing of the above-mentioned steps S10 to S70, the image sensors DUT′ are positioned with respect to the upper contacts 317f, so in this picked up state, in the image sensor test apparatus according to the present embodiment, the input and output terminals HB of the image sensors DUT′ contact the sensor side connection lines 317f1 of the upper contacts 317f.

In the above way, when the positioning of the image sensors DUT′ with respect to the upper contacts 317f ends, the alignment of the positions of the image sensors DUT′ is started. At step S80 of FIG. 39, in the state with the suction pads 314c of the contact arms 315′ picking up the image sensors DUT′, as shown in FIG. 43, the distance L1 from the front ends of the abutting members 317d of the contact arms 315′ to the movable stage 3211 of the alignment system 320′ and the distance L2 from the light receiving surfaces RL of the picked up image sensors DUT′ to the movable stage 321′ become substantially the same (L1=L2). By making the contact arms 315′ descend from this state by the amounts of the distance L1, the abutting members 317 can be made to abut against the alignment system 320′.

After making the abutting members 317 of the contact arms 315′ abut against the movable stage 321′ of the alignment system 320′ and push against is by a predetermined pressure, in the same way as steps S100 to S180 of FIG. 24 in the first embodiment, the processing of steps 500 to 3180 of FIG. 39 is performed and the positions of the image sensors DUT′ are aligned.

After the positions of the four image sensors DUT finish being aligned, the YS conveyor system 310 slides the X-axial direction support member 311a supporting the movable heads 312 on the Y-axial rails 311 and positions the four image sensors DUT′ held by the suction pads 317c at the front end of the movable head 312 above the four contact parts 301′ of the test head 300. Next, the movable head 312 extends the Z-axial actuator 313 and brings the contact side connecting parts 317f3 of the contact arms 315′ into contact with the contact parts 302 of the contact parts 301′, whereby the input and output terminals HB of the tour image sensors DUT′ are electrically connected to the contact pins 3C2 through the electrically connecting parts 317f1 to 317f3.

Further, the light sources 340 emit light to the light receiving surfaces RL of the image sensors DUT′ and the tester 20 inputs electrical signals from she contact parts 301′ to the input and output terminals HB of the image sensors DUT′ to simultaneously test the four image sensors DUT′.

After the four image sensors DUT′ finished being tested, the YZ conveyor system 310 ejects the image sensors DUT′ to an unloader unit 60 and classifies them at the sensor storage unit 40 in accordance with the test results.

Note that the embodiments explained above were provided for facilitating the understanding or the present invention and were not provided for limiting the present invention. Therefore, elements disclosed in the above embodiments include all design modifications and equivalents within the technical scope of the present invention.

For example, the image sensor test apparatus according to the above-mentioned embodiments were explained as testing image sensors having microlenses, but the present invention is not particularly limited to this. For example, it may also test lens modules including related circuits for receiving image information from chips and calculating data for automatic focusing and further combined with lenses and other optical means.

1. An image sensor test apparatus bringing input and output terminals of image sensors into contact with contact parts of a test head, emitting light on light receiving surfaces of said image sensors, and inputting and outputting electrical signals with respect to input and output terminals of said image sensors from said test head so as to test at least one image sensor for optical characteristics,
said image sensor test apparatus provided with at least
a contact arm holding said image sensor and bringing the image sensor into contact with a contact part of the test head,
a moving means prove at a base side and moving said contact arm,
a light source emitting light to the light receiving surface of said image sensor,
a calculating means for calculating a relative amount of deviation of an optical axis of the light receiving surface of the image sensor to an optical axis of said light source, and
a correcting means for correcting position of said contact arm in the state holding said image sensor based on the relative amount of deviation of the optical axis of said image sensor calculated by said calculating means.

2. An image sensor test apparatus as set forth in claim 1, further provided with
a first image capturing means for capturing an image of an image sensor in the sate held at said contact arm from said light receiving surface side and
an image processing means for recognizing the relative position of said image sensor in the state held at said contact arm with respect to said contact part based on image information captured by said first image caring means,
said correcting means provided at said base side and correcting the position of said contact arm in the state holding said image sensor based on the relative amount of deviation of the optical axis of said image sensor calculated by said calculating means and the relative position of said image sensor recognized by said image processing means.

3. An image sensor test apparatus as set ford in claim 1, wherein said calculating means calculates said relative amount of deviation of the optical axis of the image sensor with respect to the optical axis of the light source based on the electrical signals outputted from the input and output terminals of said image sensor with respect to the contact part of said test head while emitting light from said light source toward the light receiving surface of said image sensor in the state contacting said contact part.

4. An image sensor test apparatus as set forth in claim 2, wherein said image processing means recognize the relative position of said image sensor with respect to said contact part based on a chip of said image sensor in the image information captured by said first image capturing means.

5. An image sensor test apparatus as set forth in claim 2, wherein said image processing means recognizes the relative position of said image sensor with respect to said contact part based on input and output terminals of said image sensor in the image information captured by said first image capturing means.

6. An image sensor test apparatus as set forth in claim 2, wherein
the apparatus is further provided with a transparent carrying surface on which said image sensor is carried,
said contact arm has an upper contact for electrical connecting the input and output terminals led out to the surface of said image sensor opposite to the light receiving surface to said contact part and
said carrying surface is movable to any position in an X-Y plane substantially parallel to said contact part.

7. An image sensor test apparatus as set test in claim 2, wherein
the apparatus is further provided with a second image capturing means for capturing an image of said contact part and
said image processing means recognizes the relative position of said image sensor in the state held at said contact arm with respect to said contact part based on image information captured by said first image capturing means and said second image capturing means.

8. An image sensor test apparatus as set forth in claim 1, wherein each contact arm is provided with a holding side arm holding said image sensor, a root side arm fixed to said moving means, and a lock-and-free means provided between said holding side and said root side arms and able to lock or fee planar movement of said holding side arm with respect to said root side arm in an X-Y plane substantially parallel to said contact part.

9. An image sensor test apparatus as set forth in claim 8, wherein each contact arm is further provided with a tiling means able to rotate said image sensor about any axis parallel to said X-Y plane.

10. An image sensor test apparatus as set forth in claim 8, wherein said correcting means has drive units moving said holding side arm freed by said lock-and-free means to any position in said X-Y plane.

11. An image sensor test apparatus as set forth in claim 10, wherein said drive units include a first drive unit moving said holding side arm in the X-axial direction in said X-Y plane, a second drive unit moving said holding side arm in the Y-axial direction, and a third drive unit rotating said holding side arm about any point win said X-Y plane.

12. An image sensor test apparatus as set forth in claim 10, wherein said carrying surface moves in said X-Y plane by the drive unit provided in said correcting means.

13. An image sensor test apparatus as set forth in claim 8, wherein each holding side arm has one or more abutting members contacting said correcting means.

14. An image sensor test apparatus as set forth in claim 13, wherein each abutting member is provided with either a projection or moss formed at a front end of said abutting member, and said correcting means is provided with the other of the projection or recess engageable with the above projection or recess.

15. An image sensor test apparatus as set forth in claim 1, wherein a reflecting means reflecting an image is provided on the optical axis of said first image capturing means.

16. A method for testing an image sensor test method bringing input and output terminals of image sensors into contact with contact parts of a test head by contact arms, emitting light on light receiving surfaces of said image sensors from light sources, and inputting and outputting electrical signals with respect to input and output terminals of said image sensors form contact parts of said test head so as to test at least one image sensor for optical characteristics,
said method for testing an image sensor provided with at least
a calculating step of calculating a relative amount of deviation of an optical axis of said image sensor with respect to an optical axis of said light source and
a first correcting step of correcting the position of the contact arm in the state holding said image sensor based on the relative amount of deviation of the optical axis of said image sensor calculated in said calculating step.

17. An image sensor test method as set fort in claim 16, former provided with
a first image capturing step of capturing an image of said image sensor in the sate held at said contact arm from said light receiving surface side and
a first recognizing step of recognizing the relative position of said image sensor in the state held at said contact arm with respect to said contact part based on image information captured in said first image capturing step,
in said first correcting step, the position of said contact arm in the state holding said image sensor is corrected based on the relative amount of deviation of the optical axis of said image sensor calculated in said calculating step and the relive position of said image sensor recognized in said first recognizing step.

18. An image sensor test method as set forth in claim 16, wherein, in said calculating step, said relative amount of deviation of the optical axis of the image sensor with respect to the optical axis of the light source is calculated based on the electrical signals outputted from the input and output terminals of said image sensor with respect to the contact part of said test head while emitting light from a light source toward a light receiving surface of said image sensor in the state contacting said contact part.

19. An image sensor test method as set forth in claim 17, wherein, in said first recognizing step, the relative position of said image sensor with respect to said contact part is recognized based on a chip of said image sensor in the image information captured in said first image capturing step.

20. An image sensor test method as set forth in claim 17, wherein, in said first recognizing step, the relative position of said image sensor with respect to said contact part is recognized based on input and output terminals of said image sensor in the image information captured in said first image capturing step.

21. An image sensor test method as set forth in claim 17, further provided with
a second imaging step of capturing an image of said contact arm in the state not holding said image sensor,
a third image capturing step of capturing an image of said image sensor in a state not held by said contact arm from the light receiving surface side,
a second recognizing step of recognizing a relative position of said image sensor with respect to said contact arm based on image information captured in said second imaging step and image information captured in said third imaging step, and
a second correcting step of correcting the position of said image sensor in the state not held by said contact arm based on the relative position of said image sensor with respect to said contact arm recognized in said second recognizing step.

22. An image sensor test method as set forth in claim 17, wherein, in said first recognizing step, the relative position of said image sensor in the state held at said contact arm with respect to said contact part is recognized further based on the image information capturing said contact part.

23. An image sensor test method as set forth claim 16, wherein said is correcting step includes a step of correcting a root side contact arm of said contact arm by making it move relative to a holding side contact arm of said contact arm in an X-Y plane substantially parallel to said contact part of the root side contact arm in the free state, then locking said root side contact arm with respect to said holding side contact arm.
